(19) United States
(12) Patent Application Publication
(10) Pub. No.: US 2010/0205179 A1
(43) Pub. Date: Aug. 12, 2010

(54) SOCIAL NETWORKING SYSTEM AND METHOD

(76) Inventors: Anthony R. Carson, Tulsa, OK (US); Bryan L. Noland, Tulsa, OK (US); Darren M. Ford, Nichols Hills, OK (US); James D. Cunningham, Tulsa, OK (US)

Correspondence Address: HOWARD & HOWARD ATTORNEYS PLLC, 450 West Fourth Street, Royal Oak, MI, 48067, US

(21) Appl. No.: 12/447,169

(22) PCT Filed: Oct. 26, 2007
(86) PCT No.: PCT/US07/22732

§ 371 Date: Apr. 8, 2010

(30) Foreign Application Priority Data
Oct. 26, 2006 (US) 60862994

(51) Int. Cl. G06F 17/30

(52) U.S. Cl. 707/740; 707/E17.044; 707/E17.089; 707/802

(57) ABSTRACT

A social networking system allows users to upload information about themselves to a remote database, preferably over the Internet. Users are able to connect to other users thus establishing links. These links may be categorized based on the relationship between the users, e.g., family, friends, co-workers, etc. The uploaded information may also be categorized using the same categories of relationships. The information of each user may then only be sent to users having a connection category that matches the information category.

### CROSS REFERENCE TO RELATED APPLICATION

This application claims the benefit of U.S. Provisional Application No. 60/862,994 filed Oct. 26, 2006, which is incorporated by reference.

### FIELD OF THE INVENTION

The subject invention relates generally to user-generated content sharing systems and associated methods of operation. Specifically, the subject invention relates to a social networking system which is accessible by a plurality of entities over a network such as the Internet.

### BACKGROUND OF THE INVENTION

User-generated content sharing systems, also known as social networking systems, are growing in popularity in use. Prior art social networking systems include MySpace, Facebook, Friendster, and Linked In, among others. These systems typically store information about a user, i.e., a “profile” of the user. Such information may include the user's name, sex, location, schools attended, course of study, occupation, birthday, hobbies, interests, etc. Furthermore, the user may upload pictures, videos, blog/diary entries, or other information as desired.

However, the core functionality of these social networking systems is the ability to connect the user to other users, such as friends, family, classmates, colleagues, and others. Thus, users of the social networking system may easily share the aforementioned information with the other users.

Unfortunately, the social networking systems of the prior art have several drawbacks. One drawback is that information is shared with other users in a generally uniform manner no matter what the relationship (friends, family, colleagues, etc.) is between the users. Thus, work colleagues may view personal information that the user may only want to share with close friends and family. Another drawback in prior art social networking systems is the uniformity of the connections between users. For example, the connection between a lifelong friend or family member is given the same weight as an acquaintance.

The subject invention seeks to solve these and other shortcomings of the prior art.

### SUMMARY OF THE INVENTION

The subject invention includes a method of determining a relative strength of a connection between two entities utilizing a social networking system. The method includes the step of calculating a quantitative index regarding the connection utilizing at least one quantitative factor. The method also includes the step of calculating a qualitative index regarding the connection utilizing at least one qualitative factor. The relative strength of the connection is then calculated utilizing the quantitative index and the qualitative index.

The subject invention also includes a method of limiting the sharing of information in the social networking system. The method includes the step of receiving information from a first user and a second user. The information from the first user is stored in a computerized database as a first user record and information from the second user is stored in the computerized database as a second user record. The method also includes the step of receiving connection data relating to a connection between the users. The connection data is stored in the computerized database. The method further includes receiving first user category data for categorizing the connection between the first user and the second user from the perspective of the first user. The first user category data is also stored in the computerized database.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a graphical representation of a user interface of the content sharing system of the present invention showing various icons for selecting the various features and functions of the system;

FIG. 2 is a graphical representation of the user interface showing a window for viewing the connections of a user of the system;

FIG. 3 is a graphical representation of the user interface showing a window for editing stories;

FIG. 4 is a graphical representation of the user interface showing a window for viewing the connections of the user in matrix form;

FIG. 5 is a graphical representation of the user interface showing a window for viewing the connections of the user in matrix form that have been filtered by the type of connection;

FIG. 6 is a graphical representation of the user interface showing a window for managing the connections of the user;

FIG. 7 is a graphical representation of the user interface showing a personal digital clone of the user;

FIG. 8 is a graphical representation of the user interface showing a window for viewing stories;

FIG. 9 is a graphical representation of the user interface showing a window for viewing places associated with the user;

FIG. 10 is a block diagram showing one embodiment of the system and detailing various computer components and the interconnections;

FIG. 11 is a block diagram showing various rack configurations for one embodiment of the system;

FIG. 12 is a block diagram showing an Associate Network application of the present invention;

FIG. 13 is a block diagram showing features and one embodiment of the personal digital clone;

FIG. 14 is a block diagram showing a gravity and momentum engine for determining the weight of connections in one embodiment of the system;

FIG. 15 is a block diagram showing the connections of the user in matrix form; and

FIG. 16 is a block diagram showing an example of timeline of a life of the user along with various time-dependent connections of stories and pictures.

### DETAILED DESCRIPTION OF THE INVENTION

The subject invention includes a user-generated content sharing system, also commonly referred to as a social networking system. The system appeals to a wide range of people by (a) including autobiographical features, (b) offering a uniquely compelling vision of perpetual life history, (c) providing effective content access control, and (d) permitting a user to add digital clone that will be able to speak for them (in computer simulated mannerisms and intelligence). The subject invention described herein also includes a related website, methods, and software products. However, for convenience, the subject invention will be referred to primarily as the system, but this should not in any way be read as limiting. Furthermore, one embodiment of the subject invention is implemented under the trade name “Immortal Space” and can be accessed via the Internet at the URL http://www.immortalspace.com. However, this implementation of the subject invention is only one possible implementation possible within the scope of the claims and therefore should not be considered limiting in anyway.

In operation, people use the system to generate blogs (i.e., web logs), journals, life stories, location information and personal profiles, as well as share photos, videos, audio files, and text documents. The system chronicles a person's life by organizing and maintaining the all content entered over time in a historical manner. The system saves selected content and organizes it along a timeline, depicting a subscriber's evolving history, values, and accomplishments.

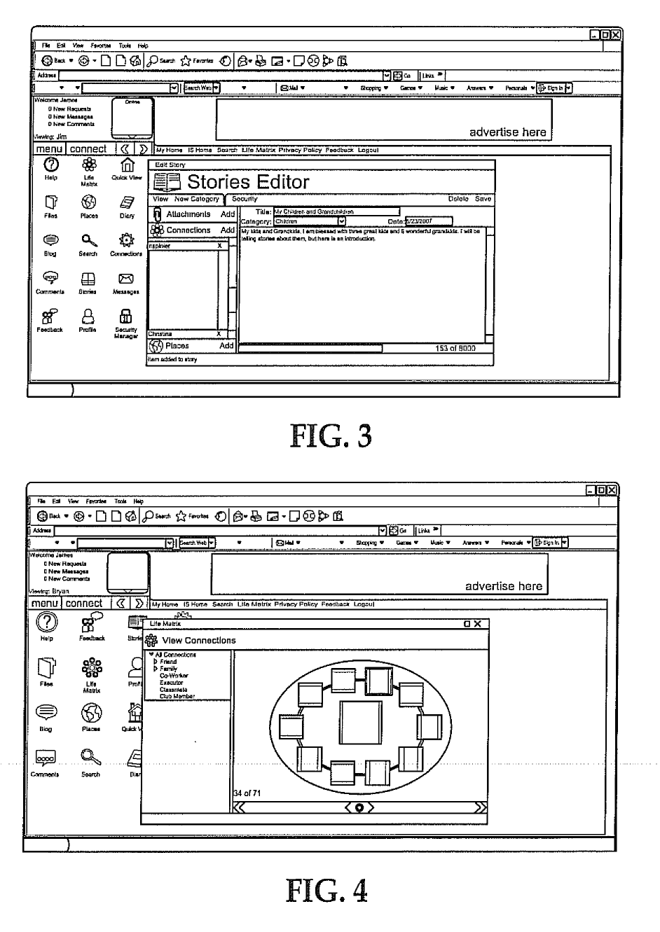

By using the system, subscribers can (1) write and share personal stories covering their life history, (2) create blogs to share their ideas, (3) record and describe personally significant places, (4) write a private journal, and (5) send internal email messages, upload and display pictures, videos, music files, graphic files and many types of text and word documents. The pictures can be displayed in slide shows. The pictures, videos and graphic files can be displayed independently, with descriptions of the content. They can also be embedded within stories, blogs and/or journal entries. A Stories Editor window is shown as part of the user interface in FIG. 3. Furthermore, pictures can be linked to stories as well as other pictures. Subscribers can define their associative networks and assign people to groups, they can set identify groups allowed access to any and all content items. They can invite other subscribers and new members to join and connect with them. They can search and explore via a LifeMatrix, as described in detail below, to find any particular subscriber or discover the relationship of subscribers.

One purpose of the invention is to provide a unique means to capitalize on the potential of the Internet to become a permanent repository of human experience. The system contains means to insure that no ones life will be lost to history. Its unique methodology makes it possible for the beliefs, knowledge, and experience of all people to be recorded and become a unique source of historical insight for future generations. The intent of the system is to eventually become a cultural institution where future generations can search, explore, and connect with their ancestors—where people in the future can become acquainted with and interact with the lives of all people, not just a few, who shaped the destiny of their family and helped determine the course of history. The system provides a space where every life can be recorded and its each experiences and contributions perpetuated and readily accessible throughout the future.

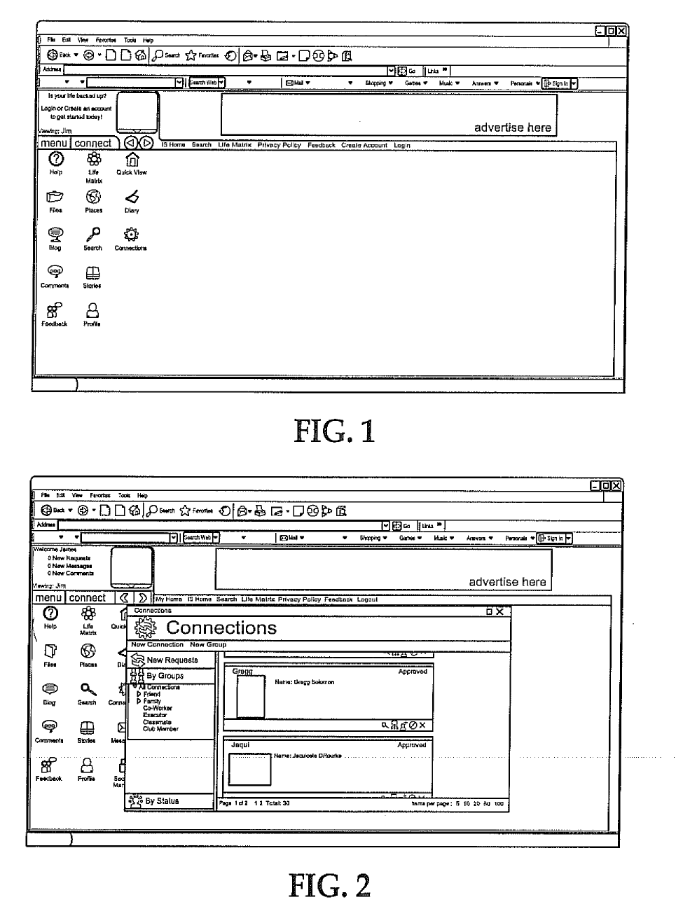

A user accesses the system via a personal computer or other computing device that is in communication with a network, such as the Internet. In one embodiment, the user utilizes a web browser, e.g., Microsoft Internet Explorer or Mozilla Firefox, to access the system, as shown in FIG. 1. The user interface of the system resembles an operating system “desktop” embedded in the web browser window. The user is able to access the various functionality of the system via the user interface. The system was developed, in part, using the AJAX programming language. Those skilled in the art realize alternative embodiments to provide access to the system to the user.

### Associative Networks

The invention solves a common problem of access control within the social networking environment. It provides a set of functions that permit users to group content and stipulate what groups of associates can see what groups of content, as well as a means to automatically change those access designations at stipulated times in the future. The means of sharing of all the historical content users generate is controlled by the methods employed by this invention. This sharing process is called “Associative Networks”, and is described below.

Recognizing the rich and varied nature of adult social and professional relationships, the system is uniquely characterized by being more than a loose, ill-defined, social network. Employing the means of Associative Networking, the system provides a tightly woven association of connections and links where people can share different aspects of their life securely with different networks of friends, family, associates and professional affiliations. For example, FIG. 2 shows the user interface with a connections window wherein the connections may be filtered by different networks (e.g., Friends, Family, Co-Workers, etc.) The LifeMatrix, described further below, is the means by which users can search their and everyone else's Associative Networks.

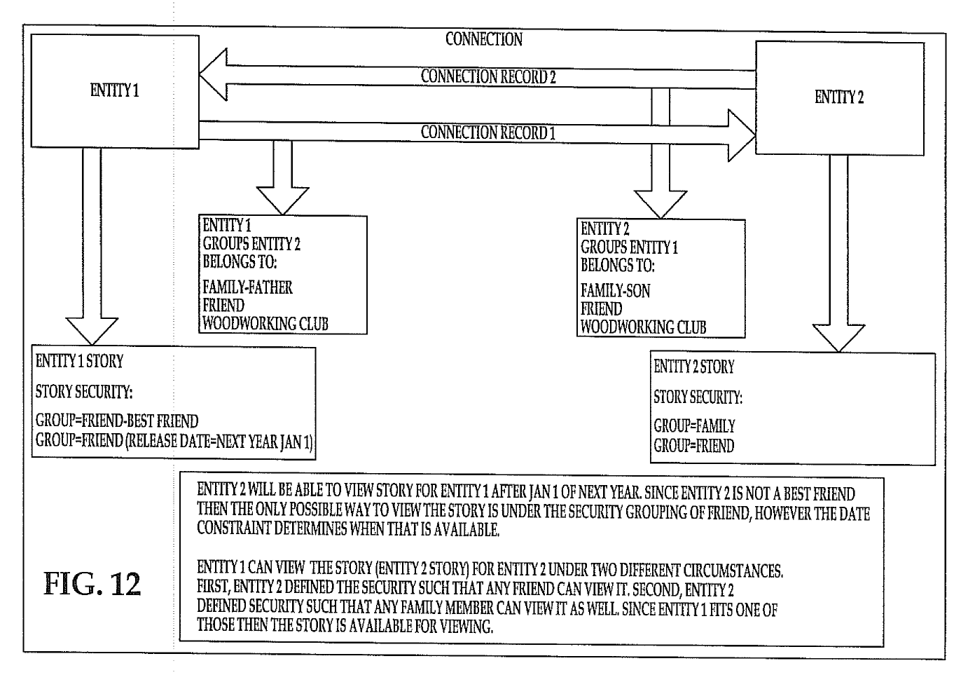

With reference to FIG. 12, Associative Networks provide two unique and valuable capabilities for the system not provided by any prior art social network or user generated content website. First, Associative Networks provide a more secure form of online networking. Associative Networks is a new method of networking between online communities. Associative Networks enable the most precise and secure control over content in the Web 2.0 industry. Associative networking means members can organize their personal and professional connections into an unlimited number of groups of their choosing and grant access to different parts of their LifeMap content (described further below) to different groups. Each photo, story, or email message may be assigned a different group and only those people the subscriber designated as part of that group will be able to see that content item on the LifeMap when they access the subscribers LifeMap. One of two purposes of this invention is to improve control of content access within social networking and all other Internet applications where users create and share their own content. Improvement in access control is vital to the secure operation of social networking style products and to protect the every increasing amount of information people post on the Internet about themselves.

Second, Associative Networks provide a more effective means of finding peoples LifeMaps. As the system is populated with data, it may contain hundreds of millions of subscriber records. As time goes by, and the system is continually populated with data, many of these records will pertain to people who lived hundreds of years before. Associative networks are the means for searchers find any individual subscriber record even if the searcher knows little about the person they are seeking. Content on individual subscribers can be found readily in the far future because the system provides a means to find anyone's content record by browsing through history following interconnected associative networks of family, friends, associates, and affiliations. Without this invention individual LifeMaps, among the potentially hundreds of millions of LifeMaps, could easily become lost. Associative networks also provide the kind of data content links and people connections that will permit the records of people to found in the far future.

No prior art social networking system makes a distinction between a connection and the nature of relationship represented by that connection. Within the system of the subject invention, the Associative Network provides an invitational/acceptance mechanism for establishing a connection is between two entities. A separate function within the system then designates what the relationship or relationships are between the two entities of the connection. Another unique aspect of this feature is that both sides of the connection can assign their own group names that defined the nature of the association; i.e., the group names do not have to be the same. This function permits a more revealing nexus of connections and establishes a thread that connects person to person to person and so on until virtually everyone is connected to everyone else through some series of connections.

People do not interact with and exchange information with just one network of friends; they have many networks including family, friends, co-workers, close friends, church friends, fishing buddies, and various kinds of associates and affiliations representing many types of relations and associations with many different types of organizations and businesses. The system provides a means for people to associate any individual content entry or designated set of content entries to specifically designated groups of people they have established a connection with during the course of their life and designate those relationships inside the system. Thus, only the people and organizations designated by the content owner will be allowed to see the content so designated for them. For example, only family members can see content the subscriber tagged for his family; friends, close-friends, and co-workers can only see content tagged specifically for them. The group designations that users create to control content access can be represent any type of connection pertinent to the user, Any number of groups can be created by the user.

Because the content on the system is intended to be accessible for thousands of years, subscribers can also designate a release date (or multiple release dates) in the future when any or all of their content can become accessible to everyone, not just to those in their associative networks. In one instance, the release date may reflect a date far in the future (e.g., after the subscriber has died).

Associative networks also provide a unique and valuable means to connect people to organizations they are affiliated with and events they participate in. For example, a business can create its history and share it within its associative networks, which consist of members, employees, and customers. A wedding could be immortalized on the system, with photos, videos, and stories shared within an associative network consisting of the participants, the family, and the friends of the couple. A novel can be represented in the system and all the participating characters can also be represented in the system which defines their set of relationships with its data structure.

Both people and organizations are participants of a connection and can be designated as belonging to any ones associative network. People are participants of events and affiliates of organizations. The organization or event has a record in the system just like a person. The system permits the organization to establish and assign people to any series of different groups that are affiliated with it, like employees, investors, vendors, customers and so on, which form separate networks for sharing organizational information, but also for establishing a nexus of connections to other related people and organizations. This capability adds a further dimension to the connectivity in the system, providing a unique means or organize and search relationships that people have to companies, churches, businesses, non-profit groups, clubs, professional or social organizations, and so on, thus providing searchers in the future a better means to search for people in the past, by not only their connection to others, but their shared affiliations with organizations.

### The Perpetual LifeMap

The system includes an interactive website where people post and share the history of their life with their friends, family and associates today, while insuring, as much as possible, that their life story will remain accessible indefinitely, potentially for thousands of years in the future. Thus, one feature of the subject invention is to insure all content entered into the system will survive intact and remain accessible for as long as some form of the Internet exists.

The means to provide this perpetual functionality within the invention includes the capability to do the following:

a. Unlike prior art social networking databases and architecture, which only provide means for the storage and display of small amounts of current information that is continuously being supplanted by more current information, the content means of the system of the subject invention is designed to solicit detailed life history information and supporting multi-media files and for the permanent storage of all content that is entered by subscribers during their life and subscription period. The interface for this is called the LifeMap.

b. Maintain the physical existence and viability of all data and its accessibility over the most universally available network.

c. Maintain the ability to display all data in its original portrayal regardless of its original recording format and regardless of whether the data is in one of the various forms of text, digital photo, graphic imagery, video, music, or other format.

d. Maintain a usable indexing scheme that insures, no matter how large the database becomes and how far into the future the database continues to grow, that all people's data can be readily found by anyone doing a search. This capability also contains the means to find the life history of people stored in the system, even when there is no other record that that person ever existed, and there is no traditional way to provide any search process with descriptive search terms pertaining to the person, which would be the case for the average person in history.

The means to support the perpetual-content intent of the invention also includes two unique aspects of a business model to support the system, namely:

(a) A portion of the revenue obtained from the commercialization of the invention is invested to provide an annuity to cover ongoing storage and Internet hosting costs for all content.

(b) The business surrounding the system is implemented with a two company strategy for helping insure the content in the system will live on indefinitely. The two companies include: (1) A first company which has all commercial rights to the website including the domain name. The first company owns the software and the content delivery mechanisms. (2) A separate “Immortal-Content” second company, such as a non-profit foundation, that owns the content, as well as holding a license to use all the software if the first company or its successors is unable or unwilling to continue offering the commercial service.

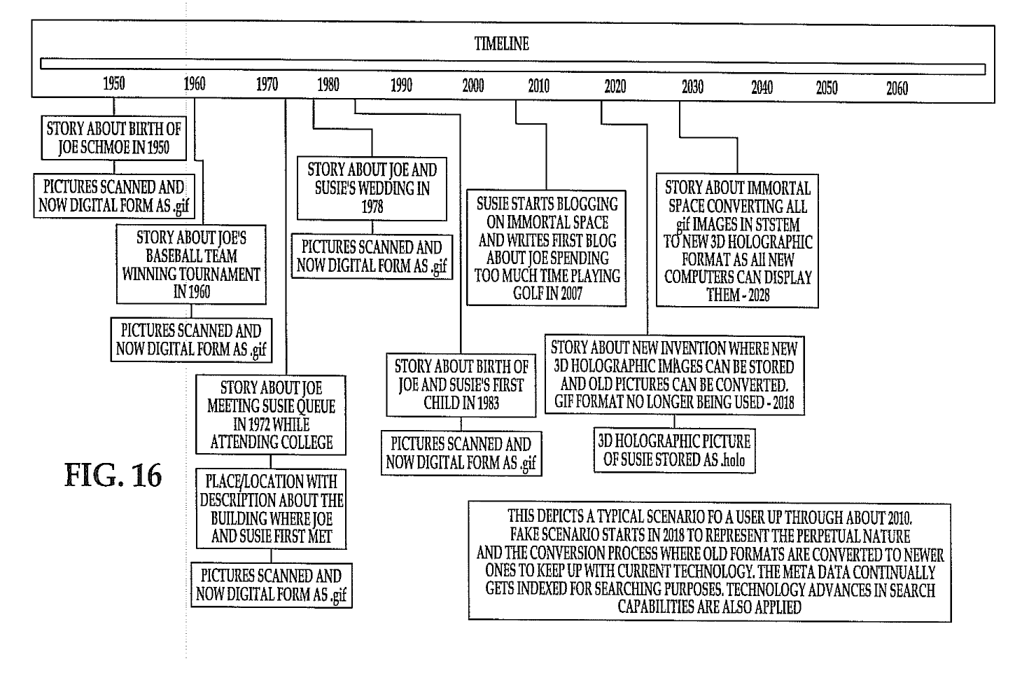

Referring to FIG. 16, a LifeMap is the main organizational means provided by the system of the subject invention. In effect, any one person's LifeMap will be the total collection of information they provide about their life history. Technically, a LifeMap is a combination of redundant database entries, digital file attachments, and proprietary knowledge files (described later). People interact with the system by creating and continuously updating their LifeMap, associating the content they enter with relevant networks of people who have also built their LifeMap, and by interacting with and searching for and viewing other LifeMaps. LifeMaps are connected within the data fabric of the system via Associative Networks (as described above). The connection elements can take four forms as follows.

(1) A person (alive or dead) who enters content during the course of his or her life or who provides content for other living or deceased relatives.

(2) An organization or any type of group (e.g., a business, school class, club, sorority, presidential library, government agency, team, institution, monument, building, etc.). It identifies all the people who are affiliated with the organization. It becomes the permanent long-term repository of all the organization's data.

(3) A linking event such as a marriage ceremony

(4) An entity (e.g., a pet, mythical figure, fictional character in a novel, gaming personalization, mascot, etc.).

The system provides a prominent and secure online space accessible for people to record their lives in the expectation that their history, accomplishments, and philosophies will live on and remain available for others to experience for many generations in the future. The system provides a ubiquitous online space where future generations will go to search, explore, and connect with their ancestors; and where future generations will go to learn about and interact with the lives of the people who shaped the history of their families and affected the course of societal development. The system provides a searchable visual map of the evolution of culture as expressed through the profusion of highly accessible individual micro-histories. The system also provides an online space where people can post comments, collaborate on ideas, and exchange viewpoints with their family, friends and associates; material which will become a unique source of historical insight for future family members, historical researchers and all people interested learning about the past.

### LifeMatrix

The total collection of LifeMaps could potentially consist of hundreds of millions of individual life histories of people and organizations. Each of these LifeMaps will be connected to other LifeMaps in two ways: (1) via various interconnected associative networks, and (2) direct links between related content items. The LifeMatrix is the way that the LifeMaps can be found and displayed.

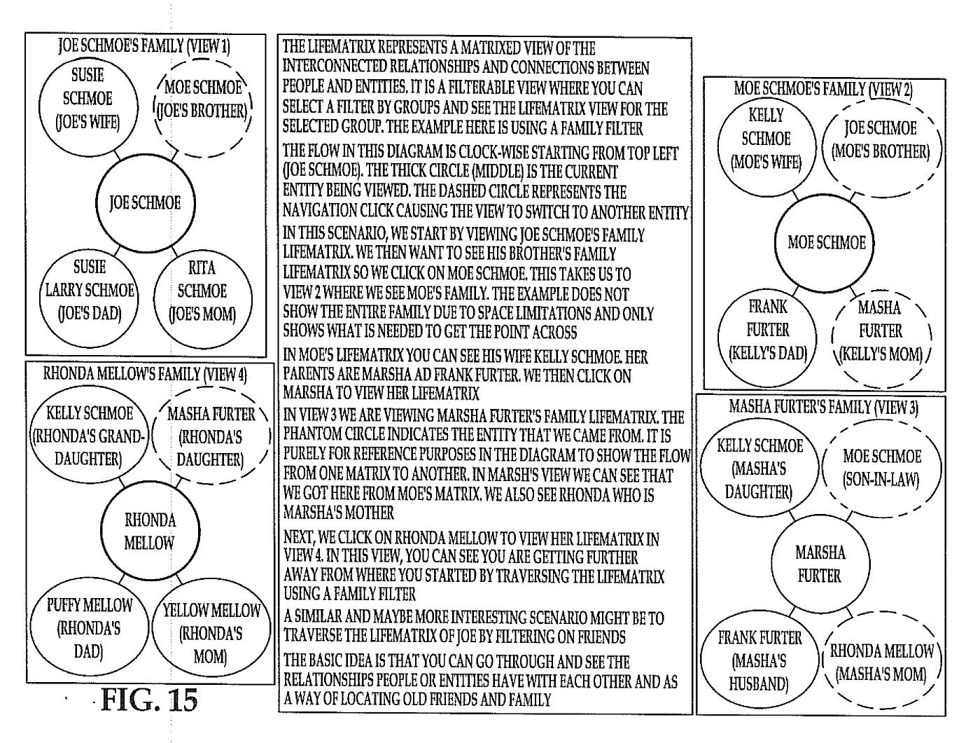

By utilizing the system, a person can document all the significant relationships they accumulate throughout the course of life, both personal and professional via the mechanism of their Associate Networks. Almost everyone utilizing the system will be part of many different member's associative networks. In fact, every person utilizing the system is likely to be linked to everyone else, either directly or indirectly, through some chain of associative networks. The system depicts this complex array of interconnected relationships by an animated graphical interface called the LifeMatrix, as is shown in FIG. 15. A subscriber or a visitor to the website of system can surf the LifeMatrix, causing the circles of association to spin to reveal an unlimited number of people in any one group of associative network. Subscribers and visitors can navigate the entire set of LifeMaps, the LifeNet, by following the entwined relationships that connect all people together. Almost any LifeMap created in the system can be found by navigating the relationship matrix created by the associative network mechanism. Most significantly, the LifeMatrix will link users today with successive generations of subscribers.

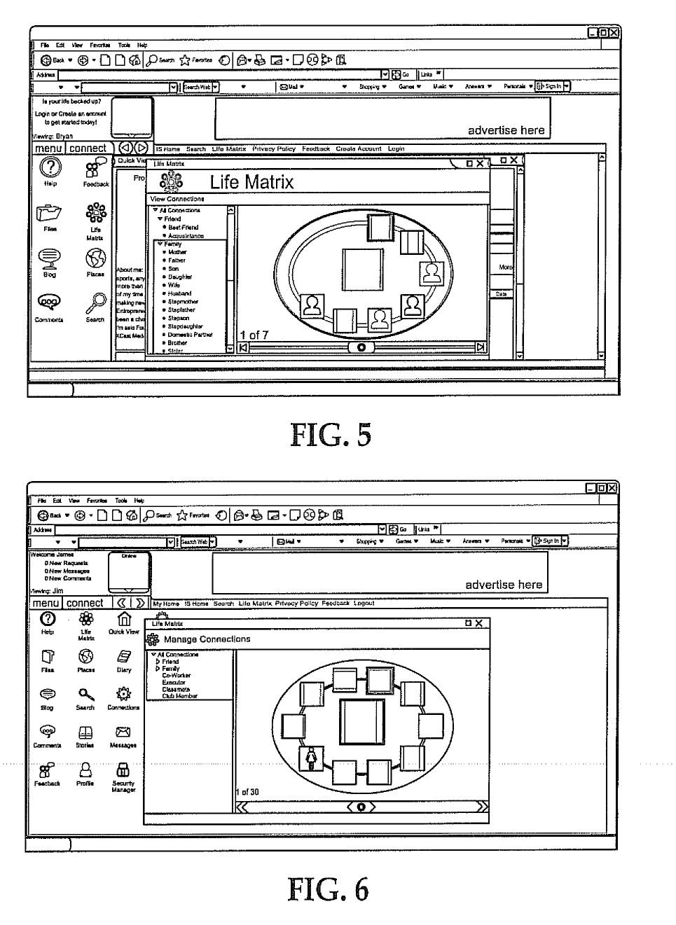

Within the LifeMatrix display, illustrated in FIG. 4, each LifeMap will be represented by a Life-Node (consisting of the name and thumbnail picture of the subscriber). The LifeMatrix is so named because each Life-Node will be graphically connected to other Life-Nodes, each connection representing a relationship with someone in their associative network—a friend, family, associate, or some affiliation with an organization. Whenever the LifeMatrix icon is clicked, the center node is a picture of the member surrounded by one of the groups in their associative networks. The slider bar at the bottom revolves the circle, bringing more LifeMap nodes into the picture. The users can select a different group to display from the list on the left of the window, as is shown in FIG. 5.

The person viewing the LifeMatrix page can indicate which type of associative network to view regarding any person. The viewer could see the subscriber's family members and from there move from LifeNode to LifeNode, going through generations and different portions of the family tree in the process. When one family member is selected, the viewing person can change the LifeMatrix display to show that person's friends, graphically displayed on the LifeMatrix page, the closest friends being closer in than the more casual friends. If one of these friends is selected, the view could be changed to that friend's professional affiliations or co-workers. The combinations and results of surfing the LifeMatrix are almost endless.

### Social Biography

The system presents a website where people share the proceedings of their life with their friends, family and associates today, while the invention provides means to (a) connect people by the grouping of their Associative Networks and (b) by linking specific content items with the record of other people who have shared in or participate in the experience, event or circumstance depicted in the content being portrayed.

The invention enables the historical content of individuals entries to be linked by related content (such as the two people telling the same story they were both involved in). As people create content within their LifeMaps, define associative networks, and build the LifeMatrix, they contribute to building a social biography, adding further user sustainability to the website. A social biography illuminates the characteristics, history, and achievements of a culture at any given time. The system's social biography emerges by linking everybody's stories, events, and places with those of everyone else in their associative networks. The chronicle of one person's life is thus associated with content items of his or her friends, family, business associates, and church or social affiliations, tracing shared activities, shared backgrounds, and similar professions and affiliations. By linking content as well as connection people and entities, the LifeMatrix as it grows will convey a view of culture and family never available before. A view derived by exploring the threads of relationships weaved in the fabric of the system (while keeping content controls in place.)

### Digital Clone

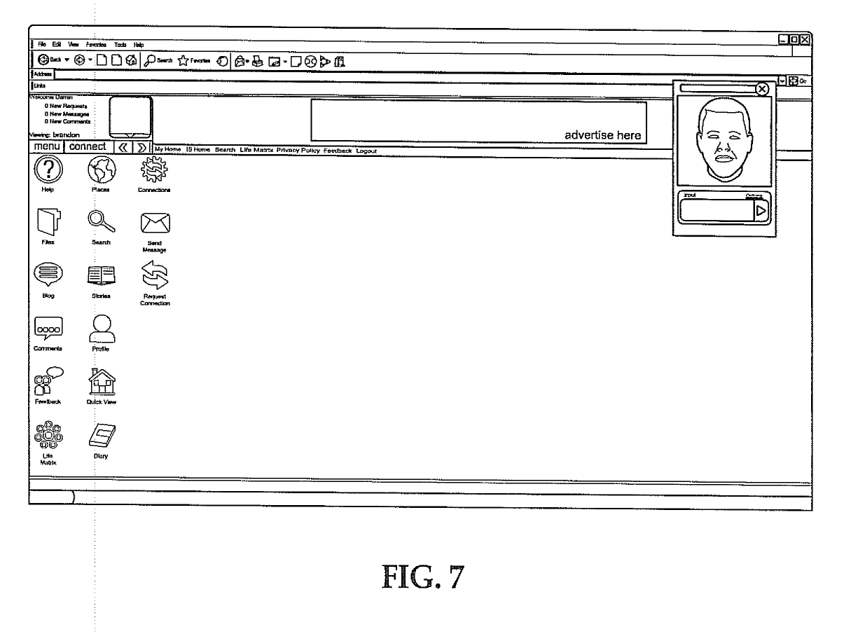

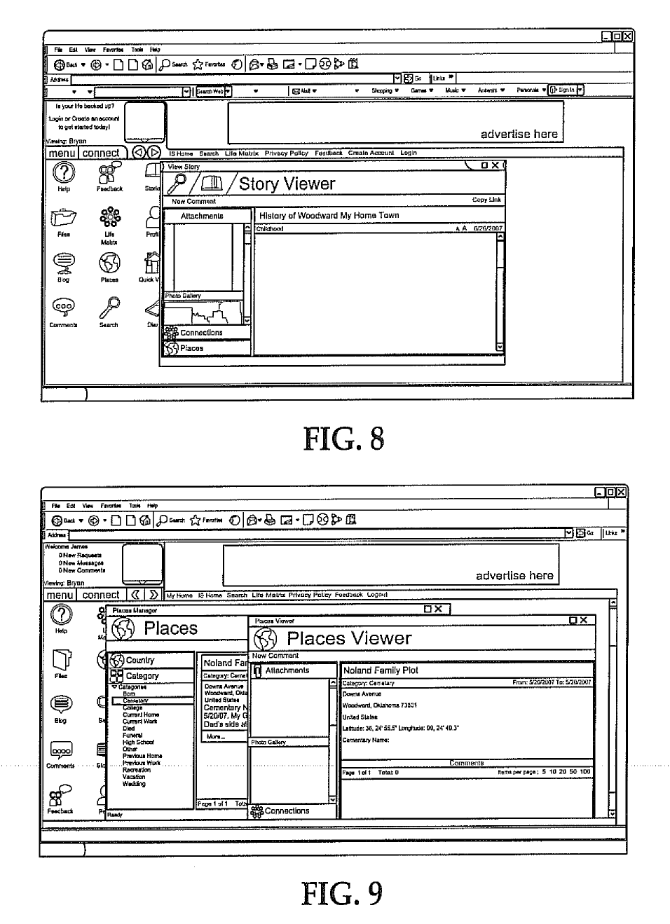

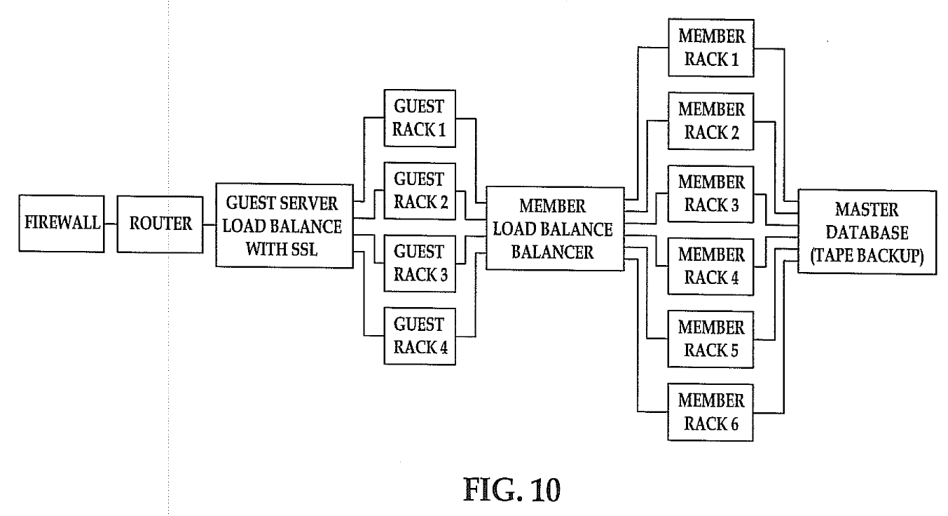

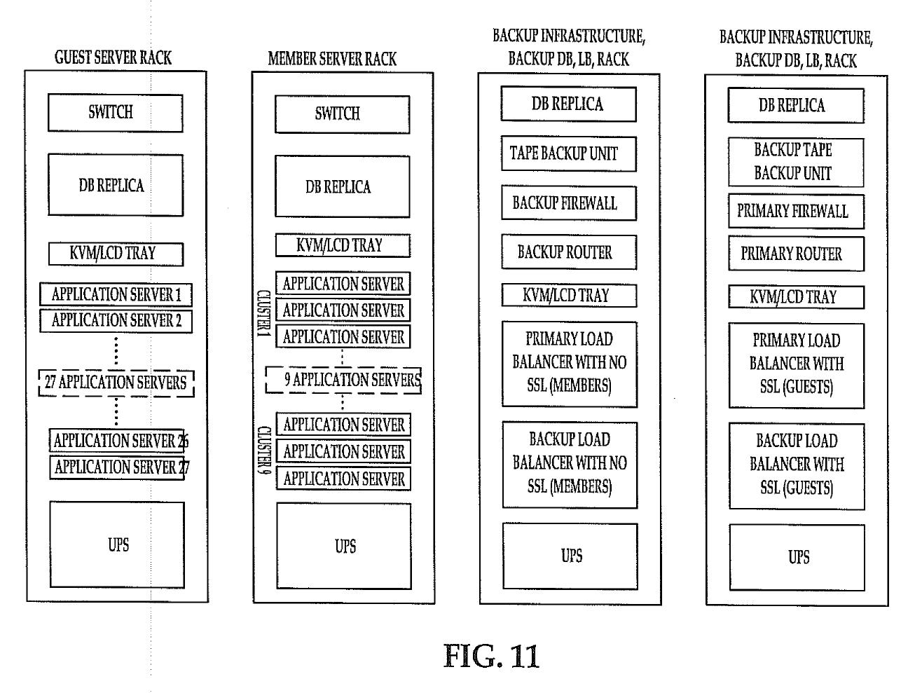

Unique to the system of the subject invention, members can create a personal digital clone to represent them on their LifeMaps. To make the digital clone realistic it is made from a digital photo of the member's face, as is shown in FIG. 7. The digital clone is created by artificial intelligence technology, called Digital Human Intelligence™ (DHI). DHI animates the member's photo to simulate facial movements and to synchronize lip movements with spoken text. DHI empowers the digital clone so it understands natural language, recognizes speech, and speaks selected content from the member's LifeMap. Each member's digital clone is capable of answering questions posed by visitors to their LifeMap and so users are able to interact with a website as if they were having a conversation with the member. This means that the great-great-great-great grandchildren of any member can interact more personally with their ancestor's content. Furthermore, members can make their digital clone available to other social networking systems, e.g., MySpace, so visitors to their MySpace page can interact with the system of the present invention and accept an invitation to build their own digital clone on the system of the present invention.

Subscribers to the system, and others, can create photo-realistic digital clones of themselves capable of carrying on a form of computer simulated “conversation” with visitors to the website, or other website that use the invention. The subscriber's digital clone draws on the content created in the system and website to answer questions posed by visitors. This feature will allow future generations of users to interact with an ancestor's digital clone so as to better experience their life and era.

This lifelike interaction of the digital clone is possible because of DHI. DHI is a unique software method which accomplishes these functions:

a. DHI includes methods whereby a digital photograph of a person, animal, object or character that is provided by a user is animated to (a) simulate lip movement in synch with speech being spoken by the digital clone, (b) mimic facial and body gestures appropriate for conversation, and (c) represent attitude and emotion.

b. DHI also includes methods for making the digital clone to interpret and speak written text or voice files, while synchronizing lip movement with the content spoken as indicated above.

c. DHI also contains a software capability of interpreting natural language input in the form of questions typed into the invention's interface, and a means to decode and match the question with the content stored in the system that comes closest to answering the question, and then fashion an appropriate written and spoken response using that subscriber's content, which also employs the capabilities presented in a and b above.

d. DHI also contains the software capability of integrating voice recognition software into the digital clone interface such that the user can ask the question in his or her voice instead of typing the question into the interface, as described in c above.

e. DHI also includes a software method of accepting and storing a users voice, in the form of a stipulated statement, that will be kept by Immortal Space until some point in the future when it may be possible to use that voice recording to create a synthesized, computer generated, voice that sounds like the user.

The digital clone player, language interpreter and the conversational key words are stored and executed on a separate server on the Internet. This can work with any website, not only the website of the system of the present invention, such that the server knows when a website is accessed by a digital clone user whereby the website that has built a knowledge file that will work with the digital clone.

DHI is a computer software system accessible from the website of the present invention. The several components of the DHI system provides a data capture means, storage means, and display methods whose function is to capture, store, and mathematically animate digital images of people for the purpose of simulating human speech, facial movements, and gestures, in synchronization with speaking written text and playing audio files. DHI maintains methods for making the animated human image manifest an understanding of human speech and for making it capable of conducting intelligent interactive conversation with the people accessing the system on the Internet by following artificial intelligent scripts. Finally DHI provides methods for creating, interpreting, and processing the artificial intelligent scripts during the interaction with system users.

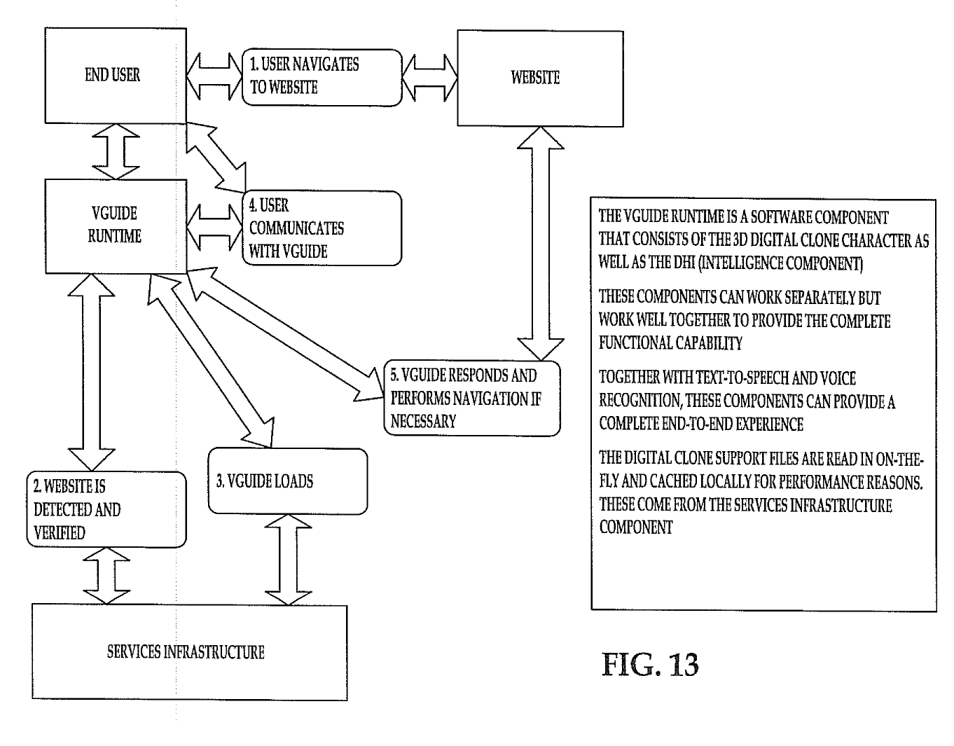

Further details and interconnections of the digital clone may be realized in reference to FIG. 13.

### Connection Relationship Momentum

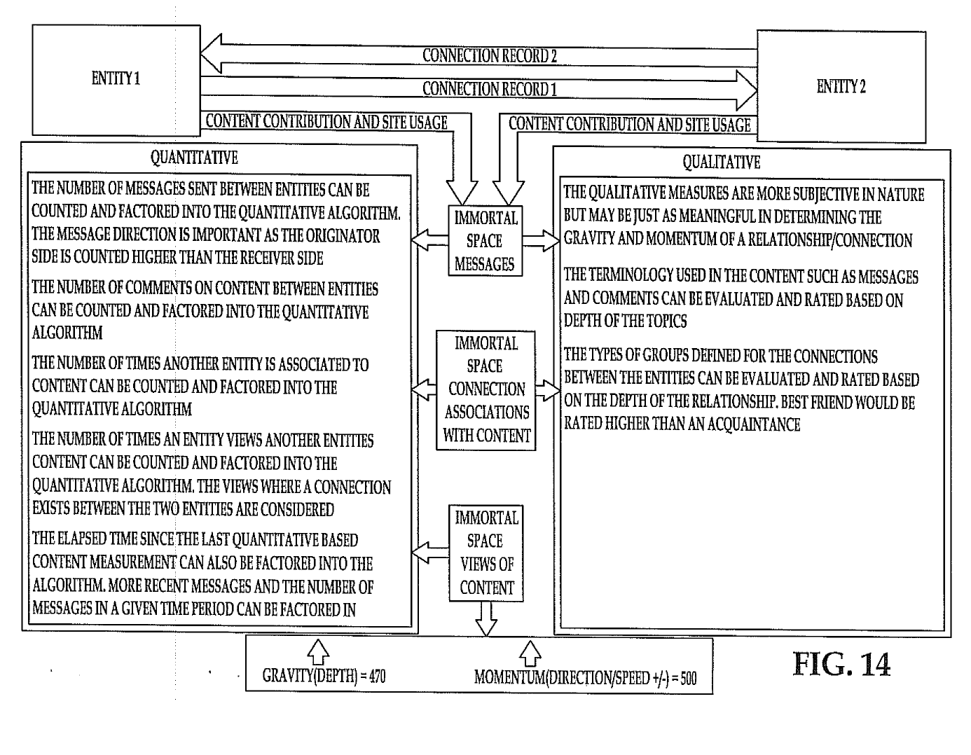

The concept of ‘momentum’ or ‘gravity’ for a given connection in the system can be defined in a number of different ways. With reference to FIG. 14, relationship momentum is defined as a relative value depicting the depth, richness, direction and gravity of a connection between two entities, in this case, user accounts. The relationship between two entities called a connection in the system is defined in both directions. These dual direction connections allow for each side of the connection to define the relationship between the two entities in their own terms. For example, a connection between Darren and Russ is defined with two records, one where Russ is the requestor and the other where Darren is the requestor. Darren can define Russ as a co-worker, friend, club member, family member or any combination of the options. He can even define sub-type relationships such as Best Friend or acquaintance. In the other direction Russ may choose to define the connection as just co-worker. The ‘type’ defined for the connection can be used in the momentum or gravity algorithms but requires adjustments using other mechanisms.

The actual value obtained using the algorithms provides a relative strength of the connection between to two entities and can provide a direction to indicate if the connection is gaining in strength or waning. Over a period of time these can fluctuate just as normal relationships do over time. These momentum values can provide a number of different uses in a social or associative network implementation. The algorithm to calculate the Momentum value or values you uses both quantitative and qualitative mechanisms that when combined can provide a decent depiction of a relationship. This does not mean that it can determine whether a relationship is necessarily good or bad but rather defines a relative strength of the communication between the two entities. The qualitative measures are more difficult to implement but can be more beneficial in some aspects.

There are a number of quantitative measurements that are used in the algorithm. Some of these quantitative measurements are based on record counts of items exchanged between two entities such as messages from one to the other, or comments from one to the other on content that has been posted. Other quantitative measurements include counting the number of connections attached to content items and even tracking views of content items by individuals.

Quantitative analysis is utilized to calculate these values. In one technique, these values are calculated as a percentage based on total quantity of records available or merely the raw count of records with relationships between the two entities. This analysis may include normalization so that overall values can be compared amongst user accounts for some of the usage scenarios.

Qualitative measurements are used to further refine the momentum or gravity values. These qualitative measurements are much more subjective and depend on the content itself rather than pure record counts. The ‘type’ or ‘types’ defined for the connection may affect the adjusted value because the mere definition of the type may indicate that the relationship is intentionally defined in a certain way. A connection defined the same way on both sides could indicate a stronger bond between the two entities rather than a connection that is defined differently. For example, if Darren indicated that Russ was a best friend and Russ indicated that Darren was just an acquaintance then the overall perception of that relationship would be different than if both had indicated Best Friend for the type. Another way that would strengthen that connection is if the connection was also defined with the co-worker type. This would tend to indicate that the two entities spend more time together on a regular basis and thus may have a stronger relative connection than that of two people that are co-workers. The same can be said of family members or significant others.

With the definitions and examples given above, one can begin to understand the depth of options and the richness that this information can provide to both the owners of the data, casual observer, and from a historical perspective. Obviously, trending these values over time would provide much more of a historical benefit than single point-in-time snapshots.

To provide several usage scenarios lets assume that we were using an algorithm to calculate the relative momentum and gravity of a relationship between two entities. If each account in the system had a multi-directional connection to another account and the algorithm had been run on those accounts then the following items are possible uses of the information:

1. Top ten list of active connections available on the home page for browsing users to navigate.

2. Meaningful sorting for connections in the connection manager or more importantly in the LifeMatrix. This would allow the stronger connections to appear first to keep from having to cycle through to find those you communicate with most often.

3. Indicators to other people browsing your content as to how strong of a relationship you have with other individuals within your local matrix.

4. Indicators to others as to the importance of other people in your life after you are gone.

5. Historical information about communication patterns and relationships.

6. Biggest gainers and biggest losers on the relationship totem pole.

### INDUSTRIAL APPLICABILITY

The following software design specification represents one possible implementation of the subject invention.

The Internet is redefining the nature and scope of human community. This is seen in many new Internet systems that are exploiting the basic the infrastructure of the worldwide web to create novel ways for people to interact with each other. The means of providing this new capability to large numbers of people did not exist before the advent of the Internet and before the recent widespread adoption of the Internet by a substantial percent of the human population. An example of some of these new people-interaction, Internet applications include MySpace and FaceBook. Systems such as these are characterized by the fact that the users of the systems create the information content of the systems. What these systems provide is the means for the content to be made accessible to many other users of system over the Internet. These websites provide a means for people to interact with each other which transcends distance and physical social groups and which brings people currently living digitally closer together. Among other things, what I.S. does is provide a means for people to interact with each other in a manner which transcends time and expands the scope of community. The invention provides a new and valuable means to redefine the nature of recorded history by allowing people to document, explain and rationalize the course of their lives and record the evolution of relationships between people over long periods of time. What I.S. provides of unique value is a means to build upon and expand the capability of social networking websites like MySpace, Facebook, Xanga; to transcend time and build connections that bring generations together and connect people to the future. In addition, whereby the growing phenomena of social networks provide a means for people to insert themselves into a dynamic and expanded social circle and to expand personal interaction with more people, Immortal Space provides an additional means for people to insert themselves, and the details of their lives, into the historical fabric of an evolving culture and to expand the recognition of their accomplishments which can be highlighted as driving factors in the evolution of a family, of an organization, and of a culture. Furthermore, whereas the existing social networking websites, expand a person's sense of personal value by enhancing their sense of belonging to a social group today; I.S.'s invention expands a person's sense of belonging to the evolution of human culture and expands a person's sense of value by having their life and their accomplishments known by people potentially thousands of year's in the future.

I.S.'s invention does not duplicate the methods, processes or intent of social ‘networks’ or ‘family trees’, but instead employ's unique methods to capture, store, and present a person's life information during the course of their life and in association and connection with the lives of their friends, family and associates, and in relation with their with association with professions, businesses, organizations and a wide range of activities and accomplishments. As will be evident by the following product description and associated claims, I.S. provides a unique set of features, methods, operations and processes that creates an entirely new application of the Internet and provides a valuable service capability that, because of the recent appearance of the Internet and the lack of computer applications like I.S., has literally never been available by any other means before and which could potentially benefit many people on the earth, now and in the future.

Discussion of Digital Human Intelligence, or “DHI”

DHI is a computer software process accessible from the Immortal Space website. It one of several components that constitutes the complete Immortal Space process. The DHI process itself consists of three major software methods dealing in understand speech input and generate speech output, animating digital images of people to mimic human conversation, and being able to simulate human conversation using artificial intelligence means. The components of the DHI system includes a data capture means, storage means, and multiple display methods. The DHI process includes:

a. a means to capture, configure and digital images of people, animals and thing,

b. a mathematical method to animate the digital images for the purpose of simulating human speech, facial movements, and gestures,

c. a means to synchronize the facial animation with spoken text so that lip movements mimic a human's lip movements, using both text data and audio files, of various standard format, as input to the animation process.

d. A method for making the animated human image manifest an understanding of human speech and for making it capable of conducting intelligent interactive conversation with the people accessing the DHI system on the Internet.

e. A computer network process for creating, interpreting, and processing the artificial intelligent scripts and data during the interaction with DHI systems users on computer networks who are (1) building A.I. scripts that describes aspects their life and activities and (2) are interacting with the AI scripts while researching peoples life histories and activities.

f. A process for creating, storing, indexing and presenting information to people in a conversational, question and answer, format whereby a digital representation of a subject person, simulating that person talking and interacting with a users via computer and network means, that portrays life history and activity information about the subject digitally simulating the subject talking about themselves and their activities.

g. A method of indexing multiple sets of information about people and their lives and .activities, that is based on the unique patterns of relation with and connection between the other records of peoples lives and activities. Connections include family, friends, associates and affiliations to professions, companies, organizations and institutions.

Discussion of the Scope

In addition to DHI discussed above, this invention covers multiple processes, systems, and methods involving various computer and network means that could provide the basis of several unique patentable claims, including the following:

1. The invention solicits, records, stores, accesses and presents individual life histories via a network and computer means, such that a comprehensive, meaningful, and insightful portrayal of a person, or non-personal entity, is manifested in a highly accessible manner, yet with precise access control.

2. This invention is unique and useful in its ability, via an Internet delivery platform, to solicit, record, store, access and present individual life histories in multiple contexts including not only family, but also friends, associates and affiliations (membership or affiliation with organizations, professions and groups of all kinds.)

3. The invention provides an information access process whereby a computer and network system generates a matrix display where each node of the matrix graphically represents one person, or entity, and graphically represents all people and entities that have a relationship with that person, and which each of them in turn is connected to other people and entities that are in relationship with them, and so on, and in such a manner that the virtual entirety of the matrix potentially includes everyone in the world, and by following any chain of nodes any person's record in the matrix can be found.

4. This invention will add a new dimension to the Internet not provided at this time by creating an internet based process designed to maintain its content of individual life histories in perpetuity. In effect the invention is designed to record, store, access and present individual life histories, and all their connections to all other life histories, forever, or at least, to be more precise, as long as some form of a universally accessible computer network exists and human civilization continues to provide the means to support the invention.

5. A unique means whereby people can input, store, organize, and index information about their lives during the course of their lives that details their life history for posterity and includes such topics as a time line of their life where they lived, what they did, what their interests were what they achieved, as well a an indication of what is important to them, what their personality was like, what motivated them, what skills they had, accomplishments they want to pass down, and who and what influenced them, what characteristics defined their life, what events shaped it the most.

6. Also included in the process of storing a persons life history within the invention, an annotated repository of a persons creations, a digital representation of what they did that they want passed down to posterity, writings, music, art, research papers, pictures of things they created, any digital media that can be attached and presented in context within the service.

7. Also included in the process of recording a persons life within the invention, A means to identify and stipulate information about family members, friends, associates and affiliates whereby a record of those people are also created and a permanent computer means established to connecting them all together in a computer database in such a manner that anyone in future can be found through connections of friends, family, associates and affiliations. Thus creating a network of peoples records where everyone can be found and made accessible through some connection with someone else.

8. The invention includes a computer graphical means for people to search, browse, surf this data base of life histories by directly inputting desired characteristics or parameters and by following the computer represented connections (matrix of nodes) between family, friends, associates and affiliations to find people's life histories.

9. The invention is not limited to life histories of people, within its processes is a means whereby its historical, autobiographical, descriptive, interactive data base records can pertain to non-human entities as well as humans. Entities can include any type of organization, group, institution, business, or process where humans manifest some purpose or goal and which a history can be maintained.

10. As described in the previous DHI section, a key unique element of the invention is the process it manifests for creating, storing and conveying life history information in a conversational means whereby the information on each person, or entity, can be spoken by a digital representation of the person to whom the information pertains, or by a digital image of a spokesperson for some other type entity.

11. A means whereby users can create their own accounts and provide the information needed to record their lives and to drive conversation with the digital representation of themselves. This means provides a method of entering information that permits access control, the attachment of pertinent digital files, a cross reference to other data portions of their life history, as well as the ability to comment on and receive comments from other about the events of their lives. This processes is intended to facilitates enter information about people's lives during the whole course of their lives. Adding, updating and deleting information, digital attachments and other material during the course of their lives so when they died the essential elements, factors and information of their lives in maintained and accessible in perpetuity.

12. A unique and central feature of the invention is the Access Control Method that it employs to annotate individual pieces of information that people enter about themselves with strict access control guidance, such that people, or entities, can control who and when information they entered about themselves is accessible to whom and when it becomes accessible to whom they designate. An important aspect of this access control involves access to the data after the person dies, each person can stipulate when access to their information will be released to everyone.

13. The invention includes a process whereby everybody that has been designated Everyone connected to everyone else—friends, family, social associates, work associates, affiliations with any kind of organizations, groups, clubs or institutions

14. In addition to recording, indexing and presenting life histories in perpetuity, the invention provide a network and computer means whereby people can post stories and comments, collaborate on ideas, coordinate events and activities, and exchange viewpoints with their family, friends and associates. The invention also provides the means to maintain this information as part of its historical base of information for all the people who participate in the system. The intent of this material is to be a unique source of historical insight for future family members, historical researchers and all people interested learning about the activities of people in the past.

15. A process whereby all family, friends, associates, and affiliations are notified, via electronic email and messages within the invention, when they are stipulated as a connection in a person's life; they are invited and provided a means to join in the use of the invention, otherwise the person creating the connection remains in charge of the connected person's record within the invention.

16. In addition, the invention provides a process whereby all people connected with someone and who has been granted rights to see information about that person, can input and place comments on a content item made available to them. In which case, the person receiving the comment is notified electronically and can accept or discard the comment.

Operation

The following description uses terms created for the Immortal Space (I.S.) product.

A software system accessed on the Internet that permits a person to create and maintain information about their life; information that they want passed on to future generations; to their descendents, to historians, and to all people interested in the evolution of a family, an organization, a culture, or of civilization itself. Immortal space provides unique means for storage and presentation to insure a person's life information will be maintained for possibly thousands of years and easily found and conveyed to future searchers in a personal and dramatic manner. This system does more than just store data, it embodies the person's life information in a digital representation of the person's image and stores the person's life information in the form of artificial intelligence (AI) scripts and AI digital image animation so that people in the future can interact with the life information of a person in the past (or a person currently alive) as if they were having an intelligent conversation with the person represented by the life information. An important aspect of the Immortal Space system is that the underlying technology, the design of the network delivery mechanism, and the design of the software facilitates continuous evolution as the Internet changes, as well as ensuring long-term survivability. In addition, the organization of the company is geared toward maximizing the likelihood that the system and its life information will be will remain available, in evolving form, for as long as civilization and some form of the Internet survive.

As will be evident from the description and claims below, the method, process and apparatus of the Immortal Space website manifests a unique application of the Internet which is destined to become one of the great Internet concepts. Unlike any website currently available, the I.S. website maintains information specifically designed to exist in perpetuity. Its purpose is to provide a ‘space’ where all people's accomplishments can outlive them; where each person's unique legacy can be perpetuated and accessible through connections with family, friends, associates and affiliations. It is a place where people's beliefs, knowledge, and insights can nourish their family and society for ages. It is meant to have far-reaching consequences by enabling a greater understanding of cultural history, by accelerating the accumulation of knowledge, and by deepening the connection between generations.

Objectives

(1) Immortal Space is to provide a prominent, and secure, online informational space accessible for people to record their lives in the expectation that their history, accomplishments, personal connections and philosophies will live on in their own digital image, available for others to experience for many generations in the future.

(2) Immortal Space is to provide a ubiquitous online space where future generations will go to search, explore, and connect with their ancestors; and where future generations will go to learn about and interact with the lives of the people who shaped the history of their families and organizations and who affected the course of societal development.

(3) Immortal Space is to provide a searchable visual map of the evolution of culture as expressed through the profusion of highly accessible individual micro-histories.

(4) Immortal Space is to provide an online space where people can post stories and comments, collaborate on ideas, and exchange viewpoints with their family, friends and associates; material which will become a unique source of historical insight for future family members, historical researchers and all people interested learning about the past.

Application of Digital Human Intelligence, or “DHI”

DHI is a computer software process accessible from and integral to the I.S. website. The several components of the DHI system provide (a) data capture means, (b) storage means, (c) indexing means and (d) multiple display methods. Partial function of the DIE system is to capture, store, and mathematically animate digital images of people for the purpose of simulating human speech, facial movements, and gestures, in synchronization with speaking written text and playing audio files stored on the I.S. website. DHI maintains methods for making the animated human image manifest an understanding of human speech and for making it capable of conducting intelligent interactive conversation with the people accessing the I.S. system on the Internet, via artificial intelligent scripts. Finally DHI provides methods for creating, interpreting, and processing the artificial intelligent scripts during the interaction with I.S. systems users who are (a) building A.I. scripts that describes their life and (b) are interacting with the AI scripts while researching peoples life histories.

Major Components:

(1) The first major component of the invention involves a DHI Plug-in. The DHI plug-in is a software method that is downloaded from the I.S. and other websites and integrated into the Internet user's web browser. Once installed, the DHI plug-in provides the capabilities of the DHI engine for creating and searching for information maintained by the invention within the I.S. website, and as described in detail below. The Immortal Space invention is not the only embodiment planned for the DHI plug-in. The DHI plug-in is also designed for intelligent website searching, providing a sales person like interface for websites that subscribe to XCast Media's VGuide services. VGuide services and the use of the DHI within this application are described in a separate patent.

(2) The second major component of the Immortal Space invention involves the Immortal Space website, which is designed to interact with the DHI plug-in. The I.S. website is described in detail below, in the same named paragraph.

The methods employed by the DHI Plug-in and the I.S. website include the following means and processes:

The I.S. LifeMap:

A LifeMap (a term to be copyrighted by XCast) is a set of computer records that a person creates in the course of using the I.S. website, which will store the content of that person's life history and information.

All LifeMaps will be maintained in perpetuity on the I.S. website. Each LifeMap will contain life information organized in multiple categories called LifeRegions, with each LifeRegion maintaining different types of information about the person.

An online software means will be provided for people to be guided through the process of providing information about themselves for each LifeRegion; that means to be provided on the I.S. website and encompass a wide range of information about their history, their accomplishments, their philosophies, as well as their family, friends and associates.

This life information will be prompted for and stored in the LifeMap by the I.S. website software will include textual material, digital photographs, digital document files, digital music and sound files, digitized art and graphical material, and all other types of information that can be stored in a digital form. A method and system will direct people to tell their life stories, input their photos, their creations, and written documents, as well as create a life-journal and post their final words.

The system will also prompt people to identify family, friends and associates; and subsequently, the system will provide a process that invites these people, over the Internet, to build their own LifeMaps within the I.S. system, thus establishing a permanent connection between these LifeMaps for presentation in the future.

A method will be provided to permit people creating and storing their life information within the I.S. website to control ensuing access to this information via the Internet, such that only certain categories of information in a LifeMap will be displayed to certain categories of people accessing the site.

Another I.S. means maintains strict access control and enforces stringent physical and access security procedures, as well as ensure redundant data storage and recovery procedures in case of failure of any part of the LifeMap data store. LifeMaps are meant to be immortal, relatively speaking, and the system contains means for long-term availability of the information contained in each LifeMap. A means for maintaining and restoring multiple copies of all LifeMap data stores is integral to the I.S. Website, as well as a database method that separates the database created and used by the users while creating their LifeMaps from the database that is subsequently accessed by people wanting to search for and review information within a LifeMap; with such access only database being a replica of the original database storing the information input by the creator of the LifeMap.

How a LifeMap Differs from a Family Tree

A LifeMap is meant to different from a “family trees” commonly found on genealogy websites, in the following ways:

(1) In a LifeMap, each person creates their own information, and each entry contains considerably more information about their life, their beliefs, the things that formed their personalities, examples of the things they created, descriptions of what they achieved and accomplished; all with a wider purpose than just indicating a family placement.

(2) In a LifeMap people are graphically connected within the I.S. website to other people not only by family association, but also to by their associations with friends, their professional associates, by their classmates, military unit comrades, and other meaningful associations. In addition, they are connected by common professions, by common interests, common hobbies, and common accomplishments.

(3) Subsequent access to LifeMaps can be made through not only family association, but by all the associations identified above. Family trees are restricted to identifying connections between people in a family, LifeMaps are not restricted to just one family and the result is that connections can be found between all people for all time.

LifeMaps—Methods Enabling a Non-Personal Content Focus

Although the description of LifeMaps given above relates to their use to input, store and present personal information, another unique means of information storage is employed in the implementation of the I.S. website—namely to input, store, and present information on groups, such as companies, organizations, and clubs. The subsequent search methods are also uniquely designed to apply to groups as well as people. And because, I.S. uses a means to invite all the members of the organization to build their personal LifeMatrices, I.S. enables a method, not previously available, for any kind of group to record their history in concert with the history of the people that make up the group for an extended period of time.

Indexing the LifeMap for Long-Term Accessibility.

Relationship Index

(a) I.S. incorporates unique means to index and find individual LifeMaps. This indexing means constitutes is an important and qualifying aspect of the I.S. system. Unlike any other known computer system that indexes people's records, LifeMap information records stored in the I.S. website are indexed by their unique pattern of connections with other LifeMaps—their Relationship Index. This index scheme and the search method that employs the access scheme take advantage of the fact that all people are connected to and have a specified relationship with, (i) other people, such as friends, family and associates, and are connected (ii) to entities such as companies, organizations, and clubs. It is impossible for two people to have the same relationship index, even twins who have the same family and maintain the same relationships and do the same work will be separated from each other by the fact they are siblings. The Relationship Index is needed because of the potentially large number of LifeMaps with identical names and the unavailability of unique identifiers that would be largely known by future searchers. Even social security numbers won't work as indexes that would be effective for hundreds of years, because numbers are reused after people die, even assuming future searches of LifeMaps would have a way of knowing them. Life Indexes are automatically created by the I.S. system. The index for each LifeMap will be derived from the various associations with people and organizations that the person indicated in their LifeMap, in response to the prompting methods used by the I.S. website. How the Relationship Index is used to find people's LifeMaps will be disclosed in the following description of the “Life Matrix” portion of the I.S. website.

The value of this Relationship Index method is (i) using I.S.'s searching methods people's LifeMaps can be found a hundred years from now, even when thousands of LifeMaps have the same name, with just general knowledge of the person, (ii) I.S.'s searching methods also provide a means for LifeMaps to be found be working backwards from any known relation and following various relationship vectors along various relationship trails (of which a “family tree” is just one example type,) and (iii) using I.S. LifeMap surfing methods the Relationship Index can be used to research information of sets of people, and not just one person, a set who match a certain group of relationship (for example, all people who lived in some town, at some period and who belonged to a specific church.)

(b) In addition to methods to create and use Life Relationship indexes, each LifeMap will be assigned a unique sequence number at the time it is added to the set of stored LifeMaps. This unique number is called a LifeNet Sequence Number (see the description of the LifeNet method below.) The first 1,000 sequence numbers will be reserved for company members, investors and partners, which will provide them a unique and highly visible position in the LifeNet in the future. I.S. will also provide a search means to find any specific LifeNet Sequence number (LSN). The LSN will be used to communicate the location of specific LifeMaps.

Method to Age Index Most Data Elements in a LifeMap

I.S. incorporates a means to store a multitude of data elements relating on one item of information in the LifeMap, with each data element tagged by a date. This date indexed data element can be a text, a photo, or any other digital media. This unique input, storage and presentation method provides people, who are reviewing someone's LifeMap, a means to see how that person's views, ideas, or look evolve over time. (The means of creating the multitude of dated data elements is described in the ‘LifeAuthoring’ tool description, below.)

LifeAuthoring Tool, Method for Acquiring Life-Knowledge for LifeMaps:

The LifeAuthoring tool is a software component accessible from the Immortal Space website. People will use this software component to build and maintain their LifeMap. I.S. employs two different methods within this tool to guide people in building their LifeMaps.

(1) The first method provides a means to ask people a series of questions in a structured and sequential manner which guides the user through the entire process of entering information about their lives and which results in common content categories across all LifeMaps. This question and answer means thus described will prompt for specific information, ideas, suggest topics and generally give structure to a persons thinking as they put their accomplishments, life-connections, life knowledge, creations, ideas, beliefs, attachments (pictures, writings, music, papers, any kind of digitally represented item) into their LifeMap. The questions will organized, presented and the answers stored by categories. The LifeAuthoring tool is designed to be used over a period of time, perhaps over the persons entire life span, by a means that permits people to stop at any point and come back later and add to the information previously given.

In addition to time spent building an initial LifeMap, a I.S. employs a means that will invite users every few years, via email, to come back and use the LifeAuthoring tool again to add to and update their LifeMap with new information appropriate for their current position in life. This method provides the means to implement the Age-Index method described above. In response to this capability the I.S. system stores the initial and all subsequently updated responses to questions in separate, date-sequenced, data records within the I.S. database. This storage method enables another unique method employed by the I.S. website, that of presenting a time-line of each person's life, as represented in the LifeMap, such that anyone reviewing the person's LifeMap may quickly scan all date-stamped entries for any information item, this includes a date-sequenced view of the person's photograph, thus effectively “morphing” the person's picture as they age.

(2) The second method provides a multiplicity of forms for users to till out. Some items on the form are explicit and require specific answers. Other items to be filled out are open ended and require a relative lengthy exposition written by the user. The nature of data captured via these forms includes such things as (a) individual descriptive data (DOB, nicknames, etc), (b) Life Stories, (c) personal journal entries, (d) lists of all life connections (friends, family, and associates), (e) Lists of Life Locations, places lived, places worked, places vacationed and so on, and lists of Life Attachments (pictures, documents, music files, representations of art), as well as other data items. The information contained in the forms is also Age-Indexed. The content of each form consists of a list method, with each item in the list presenting a title, a date, a name/relationships and so on, as appropriate for the kind of form.

I.S. incorporates a unique method in presenting the data entered via forms, whereby each data element listed in each form, is cross referenced by means of an icon, to data elements in all other forms. Standard icons represent each type of form, such that if a Life Story referenced a Life Location, a Life-Location icon would appear next to the appropriate title in the Life-Story list, and a Life-Story icon would appear next to the respective Life-Location entry.

Artificial Intelligent Methods for Training and Responding to User Context Sensitive Questions.

The LifeAuthoring Tool also contains an artificial intelligence means, called a LifeGuide, whereby a digitally animated avatar running on the I.S website is used to provide interactive training by talking and giving examples like a real personal trainer on the use of the LifeAuthoring tool and to respond to natural language questions from users on specific questions about using the tool.

LifeAuthoring Tool, a Method for Creating a Personal Digital Image That Can be Animated by the I.S. website.

This method incorporates the ability to make a digital picture of a person talk in a realistic manner, specifically to call y on a conversation about the information contained in a person's LifeMap. The unique process that constitutes this means, includes the following methods:

1. A person building a LifeMap downloads two digital photos of themselves, a front view and a side view.

2. The I.S. website provides a means for the user to graphically identify multiple key points on their own facial image that represent the inflection points associated with talking, including mouth movement, eyebrow movement, nostril movement, hairline movement and overall head movement.

3. Alternately, the I.S. website employs an automatic method of identifying the inflection points on a digital image.

4. I.S. also incorporates a method of mathematically modeling the human face which employs a series of polynomials that are transmitted to represent the face in movement that is closely correlated with speech of actual words and associated appropriate facial gestures.

5. A means whereby the appropriate verbal responses to questions asked by the user drive the animate of the person's digital image, based on the knowledge file created by the Life Authoring tool described above.

A Means to Automatically Discover Potential, Previously Unknown, Family Relationships in the total collection of LifeMaps

1. A method that incorporate facial recognition algorithms and which scans all the digital pictures of humans and identifies likenesses in facial features that may indicate family relations.

2. A method whereby people who have built their LifeMaps are notified that a facial likeness has been found in some other LifeMap, and whereby a link is provided that facilitates a review of that LifeMap so that the notified user can review the LifeMap and determine if that person is indeed a family member. A means is then provided that notifies the other person that a possible family member has been found and that the other person is requesting a connection to be established between the LifeMaps.

LifeNet:

A structured and indexed computer database that contains the total collection of all people's LifeMaps that were built by the LifeAuthoring Tool and maintained on a set of databases supporting the I.S. website. It contains all the databases of forms and all the knowledge files of all people who have ever built LifeMaps. Over a long period of time, the LifeNet may contain tens or even hundreds of millions of LifeMap records. Each of these LifeMaps will be linked within the index structures of the LifeNet database to many related LifeMaps, such that all LifeMaps will be directly or indirectly linked to every other. LifeMap. The result being that all people, as represented by their Life-Maps, are connected (as related by family friends, associated and group associations) within the LifeNet, which operates on the I.S. website, for all time.

LifeMatrix:

The LifeMatrix page on the I.S. website is used to find people in the LifeNet. This method is used to find a particular person, or a set of persons in the LifeNet. Its use involves a searcher who can input from 1 to 10 defining characteristics of a persons, or some group of persons, Life Relationships, which the method uses to match one or a group LifeMaps. As a result, the LifeMatrix page will display all the matching LifeMaps. The defining characteristics used in searching can include names of mother, father, cousins, professional association, club, country, timeframe of birth and so on, and all the LifeMaps with those associations are displayed. Icons of each LifeMap are displayed on the LifeMatrix page for further review. The icon will display a thumbnail picture and a couple of identifying characteristics. If the searcher sees an interesting LifeMap, the method continues by “opening” any of the icons which will cause the information associated with the LifeMap to be made available for review. The LifeMatrix consists of the totality of LifeMaps, although only a small number are displayed at a time and searching involves moving the LifeMatrix under the display window until the desired LifeMap(s) is found.

LifeNode(s)—a Method for Representing LifeMaps During Searches:

As described above, a LifeNode is an icon of a LifeMap that displays a small thumbnail picture of the person whose life in represented in the LifeMap. LifeNodes are displayed on the LifeMatrix page and used to surf the LifeNet. Every LifeNode is linked by a line to multiple adjacent LifeNodes representing a family, friend or affiliation connection between the various LifeNodes. The connection could also represent a professional association or common membership in a church, club or civic organization.

A Method for Surfing the LifeMatrix:

A second method for finding particular LifeMaps, or groups of LifeMaps, in the LifeNet is available which involves “surfing” the LifeMatrix. Surfing involves a method of following the lines of connection between LifeMaps shown of the LifeMatrix page in the I.S. website. A relationship filter method is employed in the LifeMatrix whereby the searcher can select and see displayed anyone of the types of relationship the desire. The different types of relationship that can be seen at any one time include family, friends, and affiliations/associations. Each connecting line shown on the LifeMatrix page represents either a connection to a friend, or a family member, or some association/affiliation, depending on the filter chosen by the searcher. Surfing involves the means of moving across these lines of connection by dragging LifeMap icons across the screen and dropping then in a viewing area on the I.S. LifeMatrix screen. As icons are dragged, new connected icons are exposed and the surfing can continue.

Personal DHI Avatar:

A personal avatar is the DHI enable digital representation of the person who built the LifeMap. When searchers have surfed the LifeMatrix and found a LifeMap that interests them, they may enter the LifeMap and “talk” that person's personal avatar that was stored with their LifeMap. The searcher may carry on a conversation, verbal or via chat boxes, with the personal avatar in the same manner as they would carry on a conversation with the person the avatar represents. This gives family and others a sense of connection with an ancestor that cannot be achieved by any other means.

Method of Applying DHI to LifeMaps:

DHI is a means that integrates three means of artificial intelligence used to achieve a unique melding of human like conversation capability relating to information and knowledge stored in knowledge files, which is created by the LifeAuthoring tool. The first means involves the animation of a digitized picture of the person (avatar) represented in the LifeMap, such that the animation simulates speech, with coordinated lip movement and appropriate facial gestures. The second means involves the ability of the I.S. website to cause the avatar to speak text generated by the LifeAuthoring tool, and to recognize the spoken or typed words input by the searcher. And the third means involves the I.S. DHI engine which can interpret the speech or text that was entered as a question by the searcher and then match it, using quantum probabilities established by the Life Authoring tool, to the find appropriate response garnered from the I.S. knowledge file and form database, which is then spoken by the avatar.

LifeRegion(s):

LifeRegions are a means of organizing the information in a LifeMap to facilitate effective searching. Each LifeMap record contains eight LifeRegion components, each LifeRegion component queries, stores and displays information about one specific area of a person's LifeMap. The LifeAuthoring Tool, described above, contains eight separate LifeRegion means for capturing, storing and indexing data in a LifeMap, but the exact number of LifeRegions is variable and ultimately can involve any number of LifeRegions. Once a searcher using the methods described above, finds a particular LifeMap, the life information from each of these regions can be displayed in any user selectable order. A description of the type of information entered, stored and displayed for each LifeRegion follows.

1: Life-History. general time-lined data concerning their life, birth, school, jobs, first love, marriage(s), military, key activities, and so on. This information is gathered by questions and answers and is presented to the subsequent searchers via conversation the LifeMaps personal avatar.

2: Life-Connections. ID data and pictures of a persons family, friends, associates and affiliations (i.e. churches other organizations.) People may provide pictures, relationship information, and biographical information for each of their Life-Connections. Each Life-Connection will be invited by I.S. to join the LifeNet, if not a member of the LifeNet already. I.S. will ask each persons permission before LifeMaps are connected in the LifeNet. This all subsequent LifeRegions is created by data entry forms in the LifeAuthoring tools and display in tables during subsequent searches.

3: Life-Knowledge. Quotes, pithy statements and short discourses on things that people have learned in their life and want to pass on to posterity. In addition, longer documents may be attached to a person's LifeMap that contains their writings, papers, music, drawing, art works or other professional or creative works that a person wants preserved for the future.

4: Life-Attachments. A number of digital attachments to a LifeMap including pictures pertaining to a persons life (i.e. family, houses, land, boats, cars) and other types of digital files, representing anything that the client is proud of and wants to save for posterity.

5: Life-Locations. The designation of various geographic locations (by country, region, city, neighborhood) where a person lived at any and all stages of their life. No specific addresses entered. Also location of where a person went to school, served in the military, worked and lived at other significant times.

6: Life-Journal and Life-Stories. The Life-Journal involves an ongoing journal that people using the I.S. website can write about their life, on some periodic basis. It will be viewable only after a specified number of years after the persons death. LifeStories involve one time stories about a persons life, family, friends and associates. It is created by prompts from the I.S.'s LifeAuthoring tool such as: “What is favorite story about yourself?”, “Tell us about your first love?” and so on, as well of free entries of stories a user wants to tell about their life.

7: Life-Correspondence. A record of correspondence done between people using the I.S. website (via the “My-Life” page on the website, as described below). LifeNet participants can correspond with each other on issues, collaborate on joint interests, and post comments with the specific intent of leaving a legacy of this correspondence in their LifeMaps for future study.

8: Life-Finale. An optional page within the LifeMap where people, if they wish, may enter their last words, to be spoken by their personal avatar after their death. In addition, at the time of death, people identified as Life-Connections may enter eulogies and comments about the person who died. Before they die, people may also attach a copy of their will and enter information about insurance policies, living wills, burial instructions, safety deposit boxes, organ donation philosophy and other death oriented items. A means will be provided to secure this information.

Structure of the Immortal Space Website:

The Immortal Space Home Page will contain methods to display interesting LifeNet statistics and randomly selected extracts from the LifeNet, such as quotes from peoples Life-Knowledge LifeRegion. The page will also contain an I.S. branded DHI Avatar intended to become a well know icon for the invention. It will also contain space for advertising (XCast's main source of revenue from the invention), as well as links to LifeNet tutorials, and links to the four major I.S. functions:

1. The LifeMap set-up page and ancillary product sales page.

2. The LifeMap Authoring Tools page, where clients, following an artificial intelligence-based question and answer format to build and maintain their LifeMap.

3. The LifeMatrix page that searchers will use to search for and surf LifeMaps.

4. The LifeMap desktop where all life regions can be accessed for both authoring purposes or for access and review purposes. The LifeMap desktop is where users can affix objects of their own choice, which others accessing their LifeMaps can access.

Use of the website will be free to all people want to store their LifeMap and search the LifeNet.

Security, Access Control, and Validation:

Security, access control and user validation are important methods incorporated as a basic capability that infuses all components of the I.S. website, which entail highly unique and valuable aspects of the I.S. website. Although the invention limits the nature of financial and location information that it allows to be entered in the Life-Map, people will be entering personally sensitive information, especially in the Life-Journal and Life-Finale LifeRegions. Accordingly security, access and validation are critical and become an integral part of the invention.

Physical Security of Data: The LifeNet will be provided for the highest level of physical security, the most massive data redundancy, and multiply layered backup processes possible.

Unauthorized Access: LifeNet and the network supporting its use will be designed to minimize, if not totally eliminate, unauthorized access by hackers wishing to steal data or corrupt data.

Controlled Access: The invention will provide strict control of who can access what information inside any LifeMap (access control determined by the person building the LifeMap by a highly unique means of selecting the categories of users that see selected data in the LifeMap). The invention will also control what information is accessible before death and after death, as directed by the client.

Validation: The invention provides a highly unique means to perform independent validation of the persons identity building their LifeMap and searching the LifeNet, using both third party credit databases, Google searches. These third party means and scoring provided by LifeConnections as they review that are requesting life-connection to their LifeMaps result in a LifeVeracity score that will be stored permanently in the LifeMap record and can not be altered by the person creating the LifeMap (although they can challenge it.) That scoring method, relating to the veracity of the LifeMap, provides a means for a group of friends or family or associates to rate whether they believe any LifeMap was created by the real person is supposedly represents. Since the LifeVeracity score will remain in the LifeMap permanently for subsequent searchers to see, if two LifeMaps portend to represent the same person, all the means of validation will help the searcher decide which is valid.

Immortal Foundation:

An essential component of the invention involves the creation and operation of a non-profit foundation that is to become the permanent repository for the LifeNet. The totally unique Immortal Foundation means is needed for the concept of Immortal Space to be credible. The Immortal Foundation insures that the LifeNet will live on indefinitely regardless of the eventual fate of XCast as a company. The foundation will also inherit the invention, XCast's software and its Internet service delivery capabilities, if XCast ceases operations. In addition, over time, it will be responsible for evolving the technology behind Immortal Space as the Internet evolves through history, such that the I.S. system remains accessible.

The invention provides:

(1) A method and system to use computers and the Internet to record and present human knowledge in a plurality of specific domains, store the knowledge domains in AI scripting files, attribute the knowledge domains to corresponding interactive human images driven by the AI scripting files, and animate the interactive human images to converse with computer users seeking information in that knowledge domain.

(2) The invention contains a means to accept an uploaded digital image of a person and identify points of the persons face that will mathematically alter the digital image

(3) The invention contains a mathematical method of directing the points on the digital image of the face to move in synchronization such that the facial gestures, head movement and lip movement simulate human speech patterns.

(4) The invention provides an artificial intelligence (AI) scripting language for the purpose of encoding knowledge in such a manner that the knowledge can be conveyed appropriately and usefully in an interaction with a person accessing the Internet.

(5) The invention provides a means for displaying the animated digital image of a human in response to an Internet user wanting to engage in a simulated conversation with a digital representation of a human and carry on a verbal or written conversation with the Internet user driven by the AI scripting language.

(6) The invention pertains to the knowledge domain specifying a wide range of life information for people, with a means to store, retrieve and associate life information for potentially all people in the world for all time.

(7) The invention provides a means to collect and present individual life information in each of the following areas and store that information, in the form of digital human intelligence scripts (DHI Scripts or DHIS) files. The segmented areas in the DHIS file includes: a chronology of life history, Life connections such as friends, family associates and common membership in all types of organizations and interests, life knowledge, digital attachments, including pictures, text documents, art and music representations, locations where that person lived at specific times, an ongoing life journal, a set of correspondences reflecting collaborations, joint projects, common endeavors stored for future study, and end-of-life words and information.

(8) The invention contains a means and system for collecting life information from individuals accessing the invention over the Internet. The means involves asking leading questions that jogs the users memory prompts them to enter all the relevant information about their life. The system involves a controlled process by which a series of context sensitive questions, which can vary by individual, are asked in the process of building the DHIS file.

(9) The invention contains a method of creating and storing the series of questions that the system will ask the individual who is building their DHIS file.

(10) The invention contains a means to interpret every answer provided by the user and converting the answer and the key terms of the question into an AI script that will be used by the DHI digital representation of the user when responding to questions from future searchers

(11) The invention relates to a computer information system accessed by the Internet that permits people to record an extensive amount of information about their lives in the expectation that their history, accomplishments, and philosophies will live on in their own intelligent digital image, available for others to experience for as long as some form of the Internet and civilization survives.

(12) The invention provides a means to input and store dated versions of the same information or digital attachment such that the user can see the same information or picture manifested over different times of the persons life.

(13) The invention provides a means for recording a person's life history and life information, as well as their digital representation; as a digital human intelligence script (DHIS), which will subsequently drive an interactive digital human image of the person, and which uses human like animation, speech simulation and artificial Intelligence Means to present individual histories as if it were the actual person conversing about their life.

(14) The invention provides a means to cross reference all aspects of a person's life history with correlated components of life histories of other people with whom they were connected with in some way in life.

(15) The invention provides a means to substitute a company, organization, club or any other organized group for a person as the focus of information in a record, thus creating the means to store and present histories of organizations that are also connected to all the histories of the people that were in the organization over long periods of time.

(16) The invention provides a computer, network, and system means to make the DHIS files accessible to all people for effectively all time, making the digital representation of people as recorded in the DHIS files immortal, for all practical purposes.

(17) The invention provides a ubiquitous online environment where future generations of people will go to search, explore, and converse with a digital representation of their ancestors; and where future generations will go to learn about and interact with the lives of the people who shaped the history of their families and affected the course of societal development.

(18) The invention provides a means of association, which provides a searchable computer link between every individual DHIS file maintained by the invention and with the entire domain of DHIS files maintained by invention. The means of association for all DHIS files includes the DHIS files of family members, friends, work and personal associates and DHIS files of people of common interests, education, location, professional background and organizational membership.

(19) The invention provides a means to associate every person's DHIS file with the total universe of people who maintain their DHIS file within the invention, such that by following the computer links of association between every persons DIES files, every person DHIS file can be discovered, so a researcher accessing the invention a thousand years from now can follow the computer links to find any person who lived at any time.

(20) The invention provides a nodal visual map, each node representing one DHIS file, on the Internet that people can use to follow the computer links to research the evolution of culture as expressed through the profusion of highly accessible individual micro-histories.

(21) The invention provides a method of displaying the DHIS files on a web page in a linked manner representing relevant association of the DHIS files.

(22) The invention provides a method of searching the entire set of DHIS files so that individual DHIS files can be dragged across the screen pulling all its associated DHIS files with it, such that by continuously grabbing and dragging associated DHIS files across the screen every and all DHIS files can be seen.

(23) The invention contains extensive methods to secure the DHIS files from unauthorized access and data corruption. The invention makes security a more integral and vital central design item than other systems

(24) The invention contains extensive methods to insure the data in the DHIS files are never lost, damaged or altered. Because of the intent to maintain the viability of the DHIS files for possibly thousands of years, data durability is more central to the operation of the invention than any other invention.

(25) The invention provides a means to control access to certain parts of every DHIS file to only those categories of people the owner of the DHIS file stipulates when building their DHIS file. This is another key element of the invention, integrated with the operation of the invention to a high degree.

(26) The invention provides a means to validate the identity of people who register to build DHIS files and who register to access DHI files by access third party databases, such as credit records and three other verifying pieces of information accessible from search engines like Google. This verification process is integral, essential and far exceeds any known similar Internet data access systems.

(27) The invention will provide a means for people to post comments, collaborate on ideas, and exchange viewpoints with their family, friends and associates; material which will become a unique source of historical insight for future family members, historical researchers and all people interested learning about the past. The invention provides a means of searching and surfing and correlating the comments from a set of DHIS files that communicated with each other via the inventions

(28) The invention provides a massively redundant, holographic, and highly secured set of storage means and locations with multiple separate paths to the Internet and independent power sources.

(29) The invention provides a means and apparatus for the creation and operation of an Internet home page that includes, display and process the following information:
Vision, mission, description of I.S., and “The Foundation”,
Description and download of basic free DHI Plug-in.
Description and download of the professional upgrade of the DHI Plug-in
Allow payment of professional upgrade and all other “upgrades” and other optional fees (which will to be identified during development) by credit card
Display of interesting statistics to encourage ongoing access of the website and entice new clients. These stats may include such things as how many Immortal LifeMaps in the LifeNet, how many were created today, how many created by various categories (sex, race, nationality and so on).
In addition to stats, the invention's home page will display a world map showing a graphic representation of how many LifeMaps in all locations.
Display of randomly selected extracts from the LifeNet, such as “Life-Quotes” selected from client's “Life-Knowledge” region of their LifeMap.
Admin Links, such as a Link to (a) XCast's corporate website, (b) a link for potential advertisers to use to arrange to advertise on our site, and (c) a link to the “Foundations” website (this website to come later). Plus standard links like “contact info” and whatever else we determine during development.

(30) The inventions home page displays the DHI avatar that appears in the side-bar whenever the Home Page is access will be used to amplify the information on the page, talk about the vision and mission, answer questions about I.S., solve common usage problems, train (tutorials), speak ‘mouse-overs’, especially over advertising, and do other things that we will define as the development evolves.

(31) The inventions home page will contain positions for placing advertising will be created for the Home Page.

(32) The invention provides a means for determining the demographic nature of the person using the authoring tool kit and LifeMatrix pages and making that non-id'd data available to advertisers so they can place targeted advertising on those pages.

(33) The inventions home page will display a significant amount of information about data security, access control, and validation

(34) The inventions home page will offer DHI supported tutorial concerning any part of building a LifeMap or searching the LifeNet. Tutorials will be sequences of web page examples choreographed with the I.S. avatar.

(35) The inventions home page will provide a link to the following four major I.S. functional pages:

1: New Client Setup Page. This page or pages will be used by people to register and setup their LifeMap account and client name (which will become a sub-domain.) The data to be entered on the setup page will be defined as we flesh out all the features of the service.

2: Life-Authoring Tools Page. This set of pages will provide access to the interactive editors that people will use over time to build and maintain their LifeMap. These editors, tailored for the eight regions of the LifeNet, will be described in subsequent tasks.

3: Searching, Browsing, and Surfing the LifeNet Pages. This set of page will be used by searchers to find individual and groups of LifeMaps. Several types of direct searching and browsing will be available, as described below. Also, a graphical navigate a nodal map called the Life-Matrix will be available to permit surfing interconnected Life-Nodes, each representing a LifeMap.

4: The Clients “My Life” Page. This page will be an option for existing clients who are returning to the I.S. site to update their LifeMap, search the LifeNet, or send and receive messages from other people in the LifeNet.

(36) The invention contains a software means and network process for downloading a plug-in for various web browsers. The inventions plug-in contains the DHI technology needed to implement the DHIS creation and access system described above. In this invention, unlike any similar embodiment, the capability provided by the DHI plug-in is not integrated with the software means provided with the I.S. website. The value of locating the DHI capability in the customer's web browser DHI instead of the website is that the DHI capability becomes available to other Internet software applications and other Internet based inventions that XCast intends to develop and offer to the Internet market in the future.

Social Nexus Aspects of the System

The majority of the following items have already been addressed in previous specifications. They are restated here to bring focus and clarity to their intent. Several new features are presented here also (they are marked as such.) These new features will round out the Social Nexus aspects of Immortal Space, aspects which are important to attract immediate users and promote high traffic volumes.

We will portray ourselves as providing a ‘social nexus’, which allows us to distinguish ourselves from a ‘social networks’ type of product.

“Nexus” means a connected group; or connection, link; or center, focus. Nexus adds a depth and richness to our product mien, as well as bring a more community focus to its operation, as described below.

The following functional elements could appear either as icons on the LifeMap desktop, or they could appear on a separate “MyLife” page that is accessed directly by signing in on the home page. The MyLife page could also be reached via an icon on the LifeMap desktop and/or the LifeMap desktop could be reached via an icon on the MyLife page.

The Elements of the Nexus:

Message Center

1. Receive invitations to accept connection with someone else (friend, family, associate, affiliation—FFAA) in the LifeNet,

2. (Send invitations to connect from within the MyConnections region)

3. Send and receive messages from other people in the LifeNet. The receipt of any message inside I.S. also prompts an email to the person advising them they have messages waiting inside the I.S. message center. Message will include the following:

a. Guest Request. A person may receive messages from people outside their four FFAA communities requesting that they be allowed to be a ‘guest’ to see some specified data item for some period of time. A yes or no is messaged back to the viewer, or a discussion is started with this person, and if approved the viewer's name will be added to the “guest permissions list, along with the specific question”.

i. A person may be in one of your communities, but not the right community to see something, so they might send a Guest Request also

b. Resume Request. A person could send a message requesting “Resume Viewing” access to a LifeMap, which if approved, via returned message, or approved after a few message are exchanged to get to know each other, which would allow them to see selected data items marked as a ‘Resume Item” by owner of the LifeMap—the items that the owner selects to “Resume Viewable” when they build their LifeMap could constitute a bio, an extended resume, or an overview of the entity, if the LifeMap wasn't for a human, or anything the client wouldn't mind releasing outside their FFAA, as long as they controlled who saw it.

c. Comment Notification. A message from the system that says that comments had been posted to a story or other item. A link in the message takes the person to that part of their LifeMap and they can review the comment. The client can then send a return message to the creator of the comment approving or disapproving it, of course if disapproved the comment is deleted from that person's lifemap. The person who owns the LifeMap can also craft a comment to the comment and have it posted with the comment; and the original commenter will be notified of the comment to his comment.

d. Journal Response Notification. The system sends a message that says someone has responded to your “MyJournal” entry (MyJournal is a blog for FFAA community to see and respond to.) A link will take you to that particular entry so you can read the response. You may respond if you wish and the system will send a message to the original responder tell them that you have responded back to them.

e. New Story Notification. The system will send you a message whenever someone else in the LifeNet has written a story that has you in it. A link will take you to that person's story. If you have the right access you can read the story. If not, you can see the title and ask the system to send a message to the story owner and ask for permanent LifeConnection and a temporary ‘Guest Access’

“Find A Connection” Button (new)

This could be a vital feature to the system's attractiveness. It is a special instance of standard search functions. Its purpose is to add excitement and virility to the system by helping people find other people in the LifeNet that they have had some associate with or whom they have something in common with. The relationship could be long lost family or mutual friends; or could be mutual professions, mutual ideas or beliefs, mutual home-towners, mutual high schools, and so on. This button could be on the MyLife page and it would bring up a form for filling in match criteria, which would lead to the Matrix display.

Community Announcements (new)

1. Compose and send an announcement to any one or all four of your communities. If it's the affiliate community, you can select an individual entity

2. Sender may request a RSVP, which will come back to this announcement center, the system will email you to tell you that an rsvp has been received.

3. A full message could come back to the sender.

4. The announcements are kept in your LifeMap forever

Events Scheduler and Calendar (new)

1. One or a series of dates, events, milestones, completion dates that can be posted on a group calendar for all in a communities to see and share (and again, any individual affiliation.)

2. Messages go out to all in the community when a new date has been posted.

3. Remarks, for all to see, can be posted pertaining to any date that is posted on the group calendar.

Projects and Issues (new)

1. Anyone in any community (or individual affiliation) can ‘Open’ an issue for discussion or ‘Start’ a project for collaboration (and scheduling via the Event Calendar above.)

2. Once and issue is opened, everyone in the community is notified via a message, and they are invited to respond to the question or issue posed. This is like a group blog. The issue stays open until the creator issues a ‘Close’. The issue, discussion, and ‘close’ remains in the LifeMap of the creator, with note of the ‘Issue’ in everyone else in the community's LifeMap.

3. Once a ‘Project’ is opened, then everyone in the community gets update messages, participates in the project with status messages and informational messages, and coordination messages. The projects milestones can be posted in the event schedule.

Configurable LifeMap Desktop
Like Windows desktop, the client can drag a copy of any icon related to any data item contained inside any of the LifeRegions icon to the desktop for emphasis. An example of this might be the “Resume” icon, “MyIdeas”, “MyCreations”, “MyJournal” (like a blog.)
Clients and viewers can add “objects” (like a link to their website) their LifeMap desktop for their use. {option} The client could make that object “stick” on their LifeMap for subsequent viewers to see (although, we can not guarantee that the link in the object remains viable forever.)

P.S. How about this for a product name to replace Immortal Space like: “Mona Vie′” (pronounced mana-vee′; means tree of life)

Add the ability to use a new users LifeConnections to find likely lists of people they may be or want to be connected too, and send the necessary emails to authorize. Do we force them to enter a few connections, or at least tell them they will have no rights to see anything without entering some connections that place them association with somebody.

ITEM: LifeMap Desktop and Life-Authoring Sub-System Tools

The Standard LifeMap page
If the user didn't enter their LifeNet Access code and password on the home page, the ID/PW entry box will be displayed on a basic login page with instructions and possibly download links to Plugin. After successful login, the LifeMap page will be displayed.
Multiple icons for working with LifeMap regions will be displayed. Basically, the same LifeMap page will display for clients building their LifeMap and for searchers viewing someone else's LifeMap, it will just be in a different mode.
The LifeMap page follows the paradigm of a Windows ‘desktop’, including the ability to customize the LifeMap desktop (customizations to be defined later) (and move icons to the LifeMap desktop possibly in version 2).
A series of icons will appear on the LifeMap desktop. Each icon will represent a different region, or “LifeRegion” of the LifeMap.
The LifeMap desktop can be accessed via the “LifeAuthoring”, or “LifeMatrix”, or the “MyLife” icons from the home page (Again this does not make sense, 3 icons taking you to the same exact place doesn't make sense).
On the LifeMap desktop there would be some sort of ‘Recent Activity’ box that would show any (a) invitations for connection to someone in the LifeNet, (b) any messages from other the LifeNetters.
Users can add “objects” the LifeMap desktop that address websites or other resources for their own use (this is low priority for phase one).
If this is an existing LifeMap, then the client's picture will appear on the LifeMap also if they have provided one, if not then a basic blank gender specific image will take it's place.
Access permissions can be set for any data element that supports security within the LifeMap. For example, each story can have separate security settings at a fairly granular level. It can be applied to an entire master type such as Family or Friends, or at sub-type level such as Family-Brother, or at an individual account level. I could give access to all Family, Friend-Best, and the user Kevin Bacon. The following categories are defined later in the document: family (immediate and other), friends (close and other), associates (work and social), and affiliates (identifies organizations, clubs, societies, churches and so on.)

1. A person, who is a member of the LifeNet, in viewing someone else's LifeMap with ‘everyone’ access, should have a means to email the owner of the LifeMap and request a ‘connection’, if the viewer is a friend, family member, associate of some kind, or affiliated with something together. If the owner of the LifeMap agrees, some mechanism should be enacted to establish the LifeConnection in both members LifeMaps.

2. Email the owner of a LifeMap whenever a comment is posted on their LifeMap, whether if be a response to a blog item or a comment to a story or any other item in their LifeMap that permits comments.

3. Provide a means to periodically, or upon some trigger event, send emails to members to entice them to update their LifeMaps. Don't do this often, and do it in association with other LifeConnections updating their LifeMaps, to entice them to update theirs.

4. Provide a means to send an email to a member when one of their “invitees” has joined the LifeNet. In particular, if they are the surrogate “owner” of the other LifeMap they need to confirm that the person trying to claim the surrogate LifeMap as their own is legitimate.

5. Users can add “objects” the LifeMap desktop that address websites or other resources for their own use. Clients have the option of making the objects stick to their desktop for others to see.

6. When the client is accessing their LifeMap, some indication of completion status of each life region.

7. In some later phase, create a ‘guest’ category, in addition to friends, family, associates and affiliates. This will provide temporary access.

LifeMap Item Entry Attributes

Item Security

For each LifeMap Item that is entered in the system an account holder can set security permissions to provide access to the item by either the general public or by account holders that have certain relationships with the current user. Default security will be private.

Attachments

For those LifeMap items that allow attachments an attachment link will be available to add an attachment to the given item. For example, if a user enters a story about a vacation trip and has pictures of the trip then they may want to attach those pictures to the story. This attachment can also have security set up on it to limit access to the attachment. This way if there are several pictures and one of them has incriminating evidence that you would only want close friends to see then you set security up so only those friends could see it. When someone is viewing another person's LifeMap then the only attachments they would see are those that they were given permission to see.

Comments

There are a number of items that allow comments. Those items that allow comments will provide an icon that when clicked will bring up the add comment entry fields. Comments will be placed in chronological order and the account owner can enter comments as well. Items that will allow comments will be Accomplishments, Attachments, Connection Location, Journal, Story, and the account itself. Comments can be deleted by the account owner or executor(s). Comments from anonymous users cannot be edited but comments by account holders that are logged in can be edited or deleted.

1. The account holder will be able to indicate a Release Date for any item entered. After that date the item is marked “everyone.”

When the LifeMap is in authoring mode (accessed via the home page LifeAuthoring icon) a multi-page form appears for data entry. In this area clients will answer a series of questions that will be put in the DHI Engine and become the knowledge base that will drive conversation between subsequent viewers and the client's avatar. Note: This is the only region in the LifeMap where the client's answers are to be built into a DHI knowledge file and where their avatar is used to disseminate the answers (although the client's avatar may be used to read stories and responses throughout the LifeMap, this is the only region where a “chat” file is employed.)

When the LifeMap is in viewing mode (accessed via the LifeMatrix icon on the home page), and a searcher clicks on this icon, the client's avatar appears in the sidebar and says something like,

“Hi! I am happy to tell you my thoughts OR “Let's Talk”. What's your name?”

At that point the user can converse with the client's avatar to discover what he/she thinks about things. But, in addition, if the user becomes impatient or doesn't want to converse with the avatar, a table view of the questions and answers will be available on the associated web page, described below.

1. The layout and functionality of the MyThoughts data entry form:

1) A series of icons will appear on the MyThoughts, each representing a category of thoughts including such things a “Love”, “Beliefs”, “Attitudes”, and so on (the first cut of about a dozen categories and associated questions is complete, we are working on the final cut now.) Clicking on a category icon will bring up a form that lists the associated questions.

2) In authoring mode, whenever the client was answering questions that appear on the form, their response will be limited to 320 characters and entered in an expandable answer box.

3) After the client types in their response, they will specify the standard Response Attributes.

4) In viewing mode, we assume the viewer will elicit information from the avatar, but the MyThoughts category icons will still have a role. If the viewer wants to bypass any part or all of the conversation, they can click on one of the MyThoughts category icons and read the questions and answers displayed in some reasonable format.

5) In viewing mode, the avatar will only provide information to the viewer permitted by the viewer's relationship with the client (friend, family, associate, affiliate.) Thus, the answer-specific access-permissions table must be incorporated in the DHI engine, such that the avatar might say, “Sorry, I can only answer that question for family members,” or “Sorry, I can't answer that question for another three hundred years.”

6) Likewise, if the viewer selected one of the MyThought's category icons to read the questions and answers, only the permitted answers would be displayed, the other answer fields would be colored yellow (or some other graphic display) and labeled something like “Not authorized.”

7) in authoring mode, a “Test Avatar” button appears on the LifeMap page for the client to request that their avatar appear and answer questions using the answers that the client has entered to that point on the form (so this will just be a temporary merge of the answers into their respective A: delimiters.)

8) Notes:
There will be dozens of questions in each category, expect a dozen categories.
The questions come from a DB, via a separate program that is to be written for XCast to use to create the questions.

2. In authoring mode, a “Publish” button will be present on the LifeMap desktop. When pressed, this button will permanently merge the answers, from all icon categories, with their specifically associated rules (A: delimiters) and thus create the knowledge file for the client and store in their LifeMap. Since the answers entered in this region can be entered during the course of multiple sessions, the ‘Publish’ button may be pressed many different times in the course of a client building their knowledge files.

3. Continuous review and edit. The client may come back in the course of the years and review and update their answers at any time.

LIFEMAP ICON 3: Quotes Icon

The Quotes area is a place to enter favorite quotes. The number of quotes that can be entered will depend on the storage space allowed for each user and has not been totally defined yet. The data entry fields available for a quote are:
Quote Text varchar (1000)
Quote Author varchar (200)

Both are required fields. The maximum length may be set below the database field size.

Security can be tied to Quotes and Quotes can be tied to connections. Comments are not available for quotes.

LIFEMAP ICON 4: Messages Icon

“Messages for me”

The Messages icon will bring up the list of message titles sent to the owner of the account. They will be in a filterable list and by default will be sorted by date descending so the newest messages are on top. Messages can be deleted by the receiver if desired.

Clicking the title will display the message content. A reply icon will be beside the title such that a message reply can be sent.

Also available in this region is an icon that when clicked will bring up a new message window where they can send a message to someone in one of two ways:
By username
Using connection list and selecting the connection account.

The available data entry fields for a message are:
Title varchar (100)
Message Text varchar (1000)

Both fields are required.

1. A person, who is a member of the LifeNet, in viewing someone else's LifeMap with ‘everyone’ access, should have a means to email the owner of the LifeMap and request a ‘connection’, if the viewer is a friend, family member, associate of some kind, or affiliated with something together. If the owner of the LifeMap agrees, some mechanism should be enacted to establish the LifeConnection in both members LifeMaps.

2. Email the owner of a LifeMap whenever a comment is posted on their LifeMap, whether if be a response to a blog item or a comment to a story or any other item in their LifeMap that permits comments.

3. Provide a means to periodically, or upon some trigger event, send emails to members to entice them to update their LifeMaps. Don't do this often, and do it in association with other LifeConnections updating their LifeMaps, to entice them to update theirs.

4. Provide a means to send an email to a member when one of their “invitees” has joined the LifeNet. In particular, if they are the surrogate “owner” of the other LifeMap they need to confirm that the person trying to claim the surrogate LifeMap as their own is legitimate.

LIFEMAP ICON 5: Connections Icon

“The important connections in my life” icon

1. Connection entry layout and operations:

a. Entries for Firstname, middlename, lastname, email address, birthdate.

b. Relationship to the client, selectable from a dropdown list (mother, brother, son, step-father, uncle, adopted son, so and so on.)

c. A free-form field (max of 320 characters) for client to describe the relationship in terms of its significance, its impact on their life, or unique or special aspect of the relationship.

d. A drop down list is used to indicate relationship

e. The rest of the standard Item Entry Attributes will be displayed, so the client can add pictures to this connection record.

f. The client clicks “Done” when they have completed entry of a new connection. After a new family-connection record is added, the system will do two things and show a confirmation of them on the display:

i. The system will check the email address to see if the ‘connection’ describes a person that has the same relationships indicated, and has an existing LifeMap (if so, then that connection's LifeMap may have already created a surrogate record (see below) for the client. If so, the surrogate record will be replaced by the actual record being created by the client and a connection approved with LifeMap of the surrogate creator.) The system will send an email and internal message to the connection telling them that the connection they established has now created a full LifeMap.

ii. If no existing LifeMap, the system will create a surrogate record which is noted as such on the screen and added to LifeMap. An email message is sent to the ‘connection’ inviting them to join the LifeNet and the status of that invite is displayed on the connections record. The display will show the request as being sent and later will indicate the date when the ‘connection’ is approved by LifeNet-connection.

2. Other connections will operate in a similar fashion.

LIFEMAP ICON 6: Accomplishments Icon

This region allows a user to enter accomplishments that they feel others would like to know. They can enter any kind of accomplishment they want it is up to them. They can provide attachments to these accomplishments as well. The accomplishment entry will allow for the following fields:
Accomplishment Title
Accomplishment Text
Date of the Accomplishment

Comments can be added to accomplishments as well.

LIFEMAP ICON 7: Life-Attachments Icon

1. While the client will be able to attach pictures and documents throughout the various regions of the LifeMap, this region is a see-all for viewing all the available attachments in anyone's LifeMap that the account holder has access to or that are made public. In addition, this area can be used by clients to attach and label any other pictures or documents they want in their LifeMaps but couldn't find a place to put them in any other LifeMap region.

2. When the Attachments Icon, on the LifeMap desktop, is selected another window appears, that shows a paginated list of image thumbnail (the image scaled down by the browser) with the Short Name/Title (varchar 50/100) of the attached pictures. If the attachment is not a picture then we will show an icon representing the file type. We will only be allowing attachments of certain well known file types for security reasons. These will be aggressively checked at upload time. Clicking on one of the thumbnails will enlarge the picture and show the link to the part of the LifeMap where the picture or document was attached, if appropriate. The viewer can follow the link and read the associated information.

3. In authoring mode, this section of the Life-Authoring Tool can be used by the client to attach general picture files or documents that don't relate to any specific region; a standard “Add” box appears for browsing and attaching.

4. For each attachment the user can enter a short name/title along with a description of the attachment. The description field in the database is varchar (500). We may not allow use of all of that space.

5. Behind the scenes will wil be capturing the filename and placing it in the url field in the database. This field is long because at some point we may allow urls that are not on our site for attachment storage.

LIFEMAP ICON 8: Places Icon

1. Clients can designate, and viewers see, all the various geographic locations where the client lived, worked, played, traveled, or served during the course of their life. Previously called MyLocations. NOTE: Add database support for type designator to indicate the type of location. Only one type designator will be allowed.

2. In the authoring mode the Clients will be able to complete a form asking the following questions. Multiple adds permitted (except for where born, of course.) In viewing mode, this information will be listed in a table, the client can edit his/her own information.

a. Where were you born?

b. Where did you go to school?

c. Where did you serve in the military?

d. Where did you live while working and raising kids?

e. Where did you have your vacation home?

f. Where did you travel?

g. Where did you retire?

h. What property did you own, but not live?

3. The following information will be entered for each item above:

a. City, state, province, postal code, country, and optional lat's and long's.

b. A free form description field, max of 320 characters, will permit the client to describe the location and its significance to him/her. May also give the address if the clients want, we will not ask for an address. (i.e. “I built that house with my own two hands out of logs that I cut down from the nearby National park and lived the next 6 months in Leavenworth”)

c. The standard access, attachments, links, and comments notation will be available.

4. Neat Feature: On the I.S. home page we could show a zoom-in map of the world with statistics showing number of I.S. Clients by location; the searcher could zoom down to a zip code to see how many I.S. people are in his area. This could help us grow virally.

LIFEMAP ICON 9: Life-Stories and Comments Icon
When selected, an interface is displayed that lists the titles of stories already entered, and when one title is selected the full text is displayed.
The client in authoring mode may edit or delete any story.
A viewer may ‘add a comment’ to any story. All other viewers and the client can view all the comments. The client will be notified, with a message on his/her LifeMap desktop, when a comment was added to their LifeMap, they can delete comments to his story if they wish.
The client may set access permissions, post attachments, and view/add/delete comments on any of their stories.
The first way to create a story in authoring mode, involves the client “adding” as many stories as they want (we may limit the number of stories), on any topic they want (as long as it doesn't violate our policies), in free-form text entry boxes. Each story may be up to 5,000 characters long.
As always, the client can access, links, attachments and comments for each entry.

LIFEMAP ICON 10: Diary/Journal Icon

1. Selecting MyDiary permits the client to write in an ongoing online private journal about his/her life on some periodic basis.

2. In authoring mode, a free form text box appears with date field and header field at the top. Maximum length of the free-form text area for any one entry is 4,000 characters.

3. Standard navigation keys are at the top of the box to let the client or the viewer browse through all the existing diary entries: first, last, next, previous and so on.

4. The client can “Add” a new diary entry or edit an existing one. The viewer, if he/she has the correct access permissions (or if the client is dead) will see a list of dates and headers in a table and can select one at a time to read, or can use the navigation keys to go the next/previous.

5. The default security for Diary is private. The user must go and add specific security to diary entries to allow anyone else to see the entry.

LIFEMAP ICON 11: Blog Icon (blogging region)

1. Selecting this icon in either mode, authoring or viewing, takes the user to what in essence is a blog site for the client to present information for comment by members of the LifeNet.

2. Individual entries can be secured to just family or friends or associates.

3. The client inputs a subject or title when they create the entry. The entry is indexed by date. In viewing mode, the interface will list of subjects/titles by date entered, that when selected brings up the full text, with possible attachments. When the text appears, a listing of comments also appears.

4. The client can initiate a new entry, a viewer can only respond to an existing entry, or to other comments.

5. Essays appear within a text box on the left and comments appear in a column on the left, or something like that.

6. The format of the page provides a space where people can post comments, collaborate on ideas, and exchange viewpoints with their family, friends and associates and keep this material in the LifeMap to become a unique source of historical insight for future family members, historical researchers and all people interested learning about the past.

7. The client can delete individual comments if they wish.

8. Limit essays to 5,000 characters and comments to 500. Limit the number of entries to 100 and the number of comments to each essay to 50.

LIFEMAP ICON 12: Finale Icon

1. When selected from the LifeMap desktop, a window presents three options, (perhaps icons): Final Words, Final Instructions, Eulogies.

2. Final Words: in view mode, this area will show a list of final statements directed toward family and friends and others. In authoring mode, the client will create and edit one, or many, final statements, each in a free-form text box. Each entry can be assigned an access-permission, so the client can say different things to family than he/she would say to friends. If possible, an entry could even be assigned to a specific person who is a member of the LifeNet. In the release date portion of the standard access permissions interface of the Response Attributes, the client could indicate a point in time when each of the entries is open to everyone (even if that was a hundred years in the future—in fact, maybe we should make 100 years a default)

3. Final Instructions: In this text box, the client can enter any information he want his family to know. Only the family will have access. Some items that could be entered include location of Insurance Policies, Location of Safety Deposit Box, Location of Important Papers, keys, organ donation philosophy and the clients “living will.” We may permit “attachments” to the entry, this way the client could attach their will, if they wanted.

4. Eulogies: In viewing mode, anyone on the LifeNet can enter up to 640 characters about this person. Anyone on the LifeNet can read all the Eulogies that were entered, as well as add one themselves. These can really just be comments but called Eulogies based on the connections in the database records.

5. Life Executors: Since the client will not want his final words and final instructions released until after death, he or she will designate three “LifeNet Executors” and assign each of them a password. All the named Executors will be messaged or emailed and her/his permission requested. Once the primary Executor tells I.S a person has died, the other executors will be notified by internal messaging and email, so they can confirm the Clients death. Normally, confirmation is required by at least two people before this section is opened. If they all have died before the client, then all this information will be opened whenever the client reaches 100 years old, unless he overrides it on his birthday.

a. If ‘setup executor’ button was pressed, a form is displayed for the client to enter the desired executors name, relationship, and a user name and password. If the executor is not already part of the LifeNet, the client will need to enter his/her's email address.

b. Once death has been independently confirmed the LifeNet Executor can get on the system and “open” the last words for the family and friends to hear. Or, maybe we could devise a means for the system to verify death at the prompting of family members.

c. Important: We should give instructions recommending that one of the executors be a law firm or an accounting firm, not a particular person. Thus if the firm survives the Life-Finale can be opened.

LIFEMAP ICON: Distinctly-Me Icon

My greatest influences, people, events, books read and so on—see notes in Armstrongs Myth book . . .

Three entry and/or display items, perhaps each with an icon, or a display table

(1) The “Distinctive Aspects of My Life” icon.

This area is for the client to enter a few events or circumstances—maybe none, but not more than five—that were defining moment or features of their lives; that were watersheds or turning points; which altered or defined the limits of their lives; or which were so important that nothing else was ever the same again. Examples: The client lost an arm in the war, they were a genius, he/she was born blind, they have three nipples, they met their spouse, their first child was born.

When this icon is selected in authoring mode:
An ‘Add’ button will cause another free-form text entry area to be display. The maximum length of an entry is 320 characters (?). NOTE: Or, perhaps we set not practical limit on any one item and let people fill their standard byte-buckets anyway they want and let them BUY additional buckets when needed.
After each entry area the standard Response Attributes list appears. Icons appear to go to and add a comment, or create a story, or a place, or connection, a link can be established that part of the LifeMap for subsequent viewers to follow.

When this icon is selected in viewing mode:
The screen may read “None were provided,” or
A list will appear that shows from one to five of the text entries.
As always, the viewer will only see entries if they have the adequate permissions.
To the side of each text entry will be an indication that there are x number of ‘Comments’ from this persons family, friends or associates, that pertain to this entry. Clicking on the view button will list/scroll through all the comments, and selecting one will view it.
In the comments scrolling window a ‘Add your own comment’ button will appear. This will cause a blank free-form text box to appear (again, no more than 320 characters in length) that will permit the viewer to add a ‘Comment’ about the associated text entry.

(2) The “Hobbies and Interests that Framed My Life” Icon

Work like (1) above, but the content is meant to describe a series of interests and hobbies that were important to the account holder's life. Things he or she did that consumed a lot of their free time. Things they did or studied or created that were important to them. Attachments may be particularly important in this category.

(3) The “Intriguing Ideas that Flavored My Life” Icon

(4) The “Philosophies that Guided My Life” Icon

LIFEMAP ICON 4: MyInterests Icon

“Hobbies and interests that matter to my life”

This icon will work just like ICON 3: except for the labels and the descriptions. Another difference is that we should allow up to 10 free form entries, instead of the 5 for ICON 3.

VERSION 2.0 FUNCTIONALITY (POTENTIAL)
Custom desktop objects like browser windows to specific url that other people can see.
Guest account type support.
Links between LifeMap Data Items outside normal linking such as attachments to stories. An example would be linking stories to other stories. There will already be a fairly significant amount of linking.
Knowledge Merge files built with IS site information with navigation support.

LIFEMAP ICON 1: Avatar Builder Icon
This particular icon will only appear on the client's own LifeMap desktop page when they are in authoring mode, it will not appear when a searcher is viewing someone else's LifeMap page.
When this icon is selected, a form opens which directs the client to upload their avatar picture(s).
If the client has already entered one or more pictures in a previous session, these other pictures will all appear on the screen.
A brief description will be displayed explaining what a personal avatar is and how it is used, including the fact that the client may maintain up to 10 pictures for different ages of their life. We may not allow for more than one in the beginning but we will see how it goes.
When a new picture is downloaded, the client will be required to enter their age at the time the picture was taken. The bio file will be saved with an age attribute, so the client can save and subsequent searchers can see multiple (up to the 10) personal avatars representing different times of the client's life.
Instructions on what the picture should look like will also be displayed (such as: it should look good, include two pictures full front and one side (even if we don't use the side profile at first), show shoulder and above, show no teeth, the background should be a light, solid color, and other things we need to tell them (these instructions to be written later.)
After the client downloads a pictures, the picture will appear in an editor, for final approval to continue (or to download again.)
This editor is where the client will be able to click on the major animation points, aired/or to adjust the lines in a roto-scoping routine (or however this editor will work.) An example of a completed picture will be on the left of the editor to help the user know what they should be doing with these points. Brief instructions should be on the page, and a “Help” will be present to allow them to review more detailed instructions.
This animation editor will insure all animation points were entered by the client before they enter the “Done” button. When done, the system will create and save the resulting “bio file” in the clients LifeMap.
Also, since non-human entities are permitted in the LifeMap, the picture(s) could be animals, graphical characters, or inanimate objects. If we can figure out a way, we may want to consider insuring that the entity type, previously entered by the client in their MyProfile, matches the entity represented in the picture.

Other Functionality:

Avatar Builder
This particular icon will only appear on the account holders LifeMap desktop page.
When this icon is selected, a form opens which directs the client to upload their avatar picture(s).
a If the client has already entered one or more pictures in some a previous session, these other pictures will all appear on the screen.
A brief description will be displayed explaining what a personal avatar is and how it is used, including the fact that the client may maintain up to 10 pictures for different ages of their life.
When a new picture is downloaded, the client will be required to enter their age at the time the picture was taken. The bio file will be saved with an age attribute, so the client can save and subsequent searchers can see multiple (up to the 10) personal avatars representing different times of the client's life.
Instructions on what the picture should look like will also be displayed (such as: it should look good, include two pictures full front and one side (even if we don't use the side profile at first), show shoulder and above, show no teeth, the background should be a light, solid color, and other things we need to tell them (these instructions to be written later.)
After the client downloads a pictures, the picture will appear in an editor, for final approval to continue (or to download again.)
This editor is where the client will be able to click on the major animation points, and/or to adjust the lines in a roto-scoping routine (or however this editor will work.) An example of a completed picture will be on the left of the editor to help the user know what they should be doing with these points. Brief instructions should be on the page, and a “Help” will be present to allow them to review more detailed instructions.
This animation editor will insure all animation points were entered by the client before they enter the “Done” button. When done, the system will create and save the resulting “bio file” in the clients LifeMap.
Also, since non-human entities are permitted in the LifeMap, the picture(s) could be animals, graphical characters, or inanimate objects. If we can figure out a way, we may want to consider insuring that the entity type, previously entered by the client in their MyProfile, matches the entity represented in the picture.

ITEM: MyLife Profile—Create and Edit Routine

Link: Linked to from I.S. home page—via the “MyProfile” Icon (See Home Page spec.)

Purpose: Purpose of the following pages is to allow clients to register with Immortal Space, set-up their LifeMap, and enter and/or edit their basic Life-Profile information.

Layout: Allow for advertising space along right side of most pages (amount of screen real-estate tbd). These pages will also explain the general features and use of the LifeMap and Sidebar. See attached drawings for examples of possible screen layout (drawing to come later.) Description of the various pages follows.

MyProfile Page 1: Log-in Page

Prompt client to enter their LifeMap Access Code and Password in order to complete or edit their LifeMap, and also ask on the same page if they are a new client and wish to setup a new LifeMap.
On this page, briefly explain what a LifeMap is and how they will be building it (leave space on the screen and Jim and David will add text later.)
Also, display an explanation of the sidebar and our standard DHI and how you can use it any time to ask any questions about filing out your profile (Jim and David will prepare the explanation and knowledge file after the profile routine has been designed.)
Also, provide a standard “forget your password” routine (later, when the LifeNet gets big, we can add a routine to help them find a unique ID/password.)

IF THE CLIENT INDICATES THEY ARE NEW:

Coppa page pops up first “are you over 13” and put the terms and the privacy—accept all to go on

MyProfile Page 2: New Client Page

1. Display rules of the site and present the terms and conditions which the client must accept to proceed (David and Tim will provide the text later.) If they don't accept, go back to home page.

2. Prompt client to create a LifeMap access code and password; verify uniqueness and direct them to reenter if needed.

3. Confirm password,

4. First Name, MI, Last Name

5. Birthdate (we verify age—confirm they are over 13—don't allow over 13)

6. Email address

7. Entity (real human, character, business, animal, gamer, other)

8. Button “Create” Button

9. message to say to check email and click verification link. (surrogates get the email to invite and they have to create a uid and pw for the profile—the client goes right to login of the profile—and they enter the “required data” of surrogate.

10. than return to home page.

11. The client goes to email, opens, user clicks on verification—confirmation comes back OK and takes user to home page?

12. This page should be clean and doesn't need space for advertising.

13. Keep the brief explanation, shown on page 1, about what a LifeMap is and how they will be building it. Also, keep the explanation of the sidebar and our standard DHI and how you can use it any time to ask any questions about filing out your profile.

Note: the LifeMap access code the client creates is not meant to be disclosed, it is not meant to be a pseudonym like you typically find in social networks. Instead, since I.S. is a “social depot” (versus a social network), people use their real names. [We could also call I.S. an “interactive social depot”, or ISD]

MyProfile Page 3: Profile Entry Form, New Client

1. After a valid access code is created, display the blank MyLife Profile Form for the client to enter; may take multiple display screens.

2. See attached list of data items that are to be put on the entry form. The list will provide each item's specifications (including required and Key Field indications) and any edit rules (of course, at this time the list is still being prepared.)

3. Permit entry and edit of any and all fields, yet mark the “required data” fields so that the

4. profile can't be saved without all the required fields complete.

5. Client may stop at any time, after required fields complete, and come back later to complete the profile.

6. Clients can enter a question about the profile form and data and in the sidebar and get an answer, hopefully.

7. Provide full navigation of multi-page form.

8. Clients can “Cancel” and return to home page.

9. Clients can “Save and Exit” profile—return to home page.

10. Store the date-created in the clients profile.

IF THE CLIENT INDICATES THEY ARE AN EXISTING MEMBER OF THE LIFENET:

MyProfile Page 4: mYProfile Entry Form, Existing Client

1. Display the completed, or partially completed, MyLife Profile form for the client to complete or edit.

2. Allow them to edit any field, even if the new entry changes key fields and indexes.

3. Allow them to navigate through multiple pages.

4. “Cancel” doesn't update the profile and goes to home page.

5. “Save and Exit” the profile goes back to home page.

6. Don't let them save the profile without all required fields complete.

7. Keep the date created in the user's profile and add the last date modified to the profile record.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A method of determining a relative strength of a connection between two entities utilizing a social networking system, said method comprising the steps of:
calculating a quantitative index regarding the connection utilizing at least one quantitative factor;
calculating a qualitative index regarding the connection utilizing at least one qualitative factor;
calculating the relative strength of the connection utilizing the quantitative index and the qualitative index.

2. A method as set forth in claim 1 wherein the quantitative factors include the number of messages sent between the entities, the number of comments on content between the entities, the number of times another entity is associated to the content, the number of times one of the entities view the other entities content, and/or the elapsed time since the quantitative factors were last determined.

3. A method as set forth in claim 1 wherein the qualitative factors include the terminology used in the messages between the entities and/or the depth of the relationship as assigned by each of the entities.

4. A method of limiting the sharing of information in a social networking system, said method comprising the steps of:
receiving information from a first user and a second user;
storing the information from the first user in a computerized database as a first user record;
storing the information from the second user in the computerized database as a second user record;
receiving connection data relating to a connection between the users;
storing the connection data in the computerized database;
receiving first user category data for categorizing the connection between the first user and the second user from the perspective of the first user; and
storing the first user category data in the computerized database.

5. A method as set forth in claim 4 further comprising the step of categorizing the first user record based on input from the first user and corresponding to the categories of connections.

6. A method as set forth in claim 5 further comprising the step of sending a portion of the first user record to the second user based on the first user category data.

7. A method as set forth in claim 4 further comprising the steps of:
receiving second user category data for categorizing the connection between the first user and the second user from the perspective of the second user; and
storing the second user category data in the computerized database.

8. A method as set forth in claim 7 further comprising the step of categorizing the second user record based on input from the second user and corresponding to the categories of connections.

9. A method as set forth in claim 8 further comprising the step of sending a portion of the second user record to the first user based on the second user category data.
